(19) United States
(12) Patent Application Publication
(10) Pub. No.: US 2009/0136154 A1
(43) Pub. Date: May 28, 2009

(54) System and method for image sensing and processing

(76) Inventors: Mark F. Bocko, Caledonia, NY (US); Zeljko Ignjatovic, Rochester, NY (US)

Correspondence Address: BAKER BOTTS L.L.P., 30 ROCKEFELLER PLAZA, 44TH FLOOR, NEW YORK, NY, 10112-4498, US

(21) Appl. No.: 10/565,704

(22) PCT Filed: Jul. 24, 2003
(86) PCT No.: PCT/US03/23160

§ 371 Date: Aug. 9, 2006

(51) Int. Cl. G06K 9/36; G06K 9/32

(52) U.S. Cl. 382/280; 382/276; 382/300

(57) ABSTRACT

A system and method for image sensing and processing using the Arithmetic Fourier Transform (AFT). An image sensing array has sensors located based on a set of Farey fractions, each multiplied by a unit block size of the array. Similar sampling can be achieved by interpolating the pixel values of a conventional, uniformly spaced array of sensors. The AFT can be determined extremely efficiently by computing weighted sums of the representative pixel values. Corresponding Discrete Cosine Transform (DCT) coefficients can then be computed by scaling the AFT coefficients. As a result, the number of multiplication operations required to compute the DCT is dramatically reduced.

### BACKGROUND OF THE INVENTION

A number of important compression standards for still and video images employ the discrete cosine transform (DCT). For example, FIG. 1 illustrates a standard JPEG algorithm for compressing a still image. In the illustrated algorithm, the image is divided into 8×8 pixel blocks of pixel intensity values (e.g., illustrated block 102). For each 8×8 block 102, the two-dimensional (2-D) DCT is computed (step 104). The DCT coefficients are scaled, quantized, and truncated (i.e., rounded off) (step 106) to retain only the information that is most important for accurate perception by the human eye. For example, because the eye is relatively insensitive to high spatial frequencies, and because the largest DCT coefficients are typically those representing the lowest spatial frequencies, many of the high-frequency DCT coefficients can be rounded to zero in the quantization step 106. The quantized coefficients are then entropy encoded—typically using Huffman encoding—for more compact representation the remaining, non-zero DCT coefficients (step 108). The above-described compression scheme can, for example, be applied separately to different spectral components of a color image—e.g., the red, green and blue pixels in an RGB image or the luminance-chrominance values of the image. Because the DCT is a linear operation it can be applied separately to any linear combination of RGB pixel values.

The 2-D, N×N point DCT is defined as follows,

$$\begin{matrix}D C T \{ A \} ( k , l ) = {\sum }_{n = 0}^{N - 1} {\sum }_{m = 0}^{N - 1} α ( k ) \cdot α ( l ) \cdot A [ ( n + \frac{1}{2} ) T , ( m + \frac{1}{2} ) T ] \cdot cos ( \frac{π \cdot k \cdot ( 2 n + 1 )}{2 N} ) \cdot cos ( \frac{π \cdot l \cdot ( 2 m + 1 )}{2 N} ) & ( 1 a ) \\ where \text{:} \\ α ( 0 ) = \sqrt{\frac{1}{N}} , \\ α ( k ) = \sqrt{\frac{2}{N}} , \\ k = 1 , 2 , 3 , … N - 1 , & ( 1 b )\end{matrix}$$

and where A denotes the sampled image, m and m denote the spatial sampling indices, and k and l denote the spatial frequency indices. Computation of the 8×8 DCT can require on the order of (2×8×8)×(8×8)=8192 multiplications, although some well known algorithms are capable of reducing the number of multiplications by a factor of 50 or more. Nonetheless, computation of the DCT typically comprises the bulk of the computations required for image compression. Furthermore, although some compression technologies—such as JPEG2000—use wavelet representations rather than the DCT, DCT-based technologies are expected to remain in widespread use for the foreseeable future.

Moreover, in addition to the JPEG standard, which is used for still image compression, there are a number of commonly used video compression standards—e.g., Motion JPEG, MPEG(1,2,4), and H.26X—which require computation of the DCT of each frame of the video frame sequence.

Currently, in most commercial applications, image compression is performed by separate digital signal processing circuits which derive DCT coefficients based on digitized image data. However, conventional DCT algorithms require a substantial amount of computing power and consume a large amount of power, which makes such image processing less attractive for devices in which power conservation is important. Such devices include, for example, mobile camera phones, digital cameras, and wireless image sensors for machine health monitoring and surveillance.

### SUMMARY OF THE INVENTION

It is therefore an object of the present invention to provide an image sensing and processing system which reduces the number of computations, particularly multiplications, required to derive DCT coefficients from image data.

It is a further object of the present invention to provide such a system which reduces the amount of power consumed by the derivation of DCT coefficients.

These and other objects are accomplished by a system which computes DCT coefficients of an image using the Arithmetic Fourier Transform (AFT). The AFT method enables computation of the Fourier transform primarily by performing additions. Other than pre-scaling of the pixel data, no multiplication is required. In hardware realizations, the greater computational efficiency of the AFT allows savings in circuit complexity, size, and power consumption, and also increases processing speed. The image is preferably sampled using non-uniformly spaced sensors, although non-uniform sampling can also be achieved by interpolation of signals from a set of uniformly spaced sensors. The AFT algorithm can be implemented in either digital or analog circuitry. The AFT techniques of the present invention, particularly the analog implementations, allow vast economies in circuit complexity and power consumption.

In accordance with one aspect of the present invention, incoming light is detected by a sensor array comprising at least first and second sensors having first and second sensor locations, respectively. The first sensor location is proximate to a location of a first extremum of a basis function of a domain transform, a basis function having one or more spatial coordinates defined according to the spatial coordinate system of the sensor array. The second sensor location is proximate to a location of a second extremum of the same basis function or a different basis function. The system includes at least one filter which receives signals from the first and second sensors and generates a filtered signal comprising a weighted sum of at least the signals from the first and second sensors. We include the special case of the foregoing in which the signal from a single sensor may comprise a filter output. In accordance with additional aspect of the present invention, incoming light is detected by a sensor array comprising a plurality of sensors, including at least first and second sensors having first and second sensor locations, respectively. The incoming light signal has a first value at the first sensor location and second value at the second sensor location. The system includes an interpolation circuit which receives signals from the first and second sensors, these signals representing the first and second values, respectively, of the incoming light signal. The interpolation circuit interpolates the signals from the first and second sensors to generate an interpolated signal. The interpolated signal represents an approximate value of the incoming light signal at a location proximate to a first extremum of at least one basis function of a domain transform, the at least one basis function having at least one spatial coordinate defined according to the spatial coordinate system of the sensor array.

### BRIEF DESCRIPTION OF THE DRAWINGS

Further objects, features, and advantages of the present invention will become apparent from the following detailed description taken in conjunction with the accompanying drawings showing illustrative embodiments of the present invention, in which:

FIG. 1 is a block diagram illustrating an exemplary prior art image processing procedure;

FIG. 2 is a diagram illustrating data processed in accordance with the present invention;

FIG. 3 is a diagram and accompanying graphs illustrating an exemplary image sampling space and corresponding domain transform basis functions in accordance with the present invention;

FIG. 4 is a graph illustrating error characteristics of an exemplary system and method for image sensing and processing in accordance with the present invention;

FIG. 5 is a diagram illustrating an exemplary image sampling space in accordance with the present invention;

FIG. 6 is a graph illustrating error characteristics of an exemplary system and method for image sensing and processing in accordance with the present invention;

FIG. 7 is a graph illustrating error characteristics of an additional exemplary system and method for image sensing and processing in accordance with the present invention;

FIG. 8 is a graph illustrating error characteristics of yet another exemplary system and method for image sensing and processing in accordance with the present invention;

FIG. 9 is a diagram illustrating an exemplary image sampling space in accordance with the present invention;

FIG. 10 is a diagram illustrating an exemplary sensor array and filter arrangement in accordance with the present invention;

FIG. 11 is a flow diagram illustrating an exemplary image sensing and processing procedure in accordance with the present invention;

FIG. 12 is a flow diagram illustrating an exemplary signal filtering procedure for use in the procedure illustrated in FIG. 11;

FIG. 13 is a flow diagram illustrating an exemplary image sensing and processing procedure in accordance with the present invention;

FIG. 14 is a flow diagram illustrating an exemplary signal filtering procedure for use in the procedure illustrated in FIG. 13;

FIG. 15 is a diagram illustrating an exemplary sensor array and filtering circuit in accordance with the present invention;

FIG. 16 is a flow diagram illustrating an exemplary image sensing and processing procedure in accordance with the present invention;

FIG. 17 is a timing diagram associated with FIG. 10, illustrating an exemplary timing sequence produced by the clock generator to generate the filtered signal S(3,12).

FIG. 18 is a diagram illustrating an exemplary sensor array and filter arrangement in accordance with the present invention;

Throughout the drawings, unless otherwise stated, the same reference numerals and characters are used to denote like features, elements, components, or portions of the illustrated embodiments.

### DETAILED DESCRIPTION OF THE INVENTION

An incoming image signal—such as an incoming light pattern from a scene being imaged—can be sampled by an array of sensors such as a charge coupled device (CCD). In accordance with the present invention, the individual sensors in the array can be distributed according to a spatial pattern which is particularly well suited for increasing the efficiency of AFT algorithms. The preferred spatial distribution for a 2-D sensor array can be better understood by first considering the one-dimensional (1-D) case. For example, to find the 1-D AFT that is equivalent to an 8-point, 1-D DCT on a unit interval (0 to 1) of space or time, 12 non-uniformly spaced samples should be used. The preferred sampling locations are (0, ¼, 2/7, ⅓, ⅖, ½, 4/7, ⅔, ¾, ⅘, 6/7, 1)—although it is to be noted that, if the entire signal being sampled includes multiple unit intervals, the first and the last samples of each interval are shared with any adjacent unit intervals. In number theory, fractions of the form k/j, where k=0, 1 . . . N−1 and j=1, 2 . . . N are commonly referred to as “Farey fraction” of order N. It can thus be seen that the above-described sampling locations—which provide the preferred set of samples for calculating an 8-point DCT based on the corresponding, 12-point AFT—correspond to an even subset of Farey fractions of order 8 defined as 2k/j, where k=0, 1 . . . 4 and j=1, 2 . . . 8.

The above-described signal samples can be used, in conjunction with a function known as the Mobius function, to compute the AFT of the signal. The 1-D AFT based on the Mobius function is well known; an exemplary derivation of the transform can be found in D. W. Tufts, G. Sadasiv, “Arithmetic Fourier Transform and Adaptive Delta Modulation: a Symbiosis for High Speed Computation,” SPIE Vol. 880 High Speed Computing (1988). The 1-D Mobius function μ₁(n) is defined as follows:

μ₁(1)=1 (2a)

μ₁(n)=(−1)^{s} if n=(p₁)(p₂)(p₃) . . . (pₛ), where pᵢ are different prime numbers (2b)

μ₁(n)=0 if p²|n for any prime number p, (2c)

where the vertical bar notation m|n means that the integer it is divisible by the integer in with no remainder. If n can be expressed as the product of s different prime numbers, the value of μ₁(n) is (−1)^{s}; otherwise, the value is zero.

Within a unit interval, the signal A(t) is assumed to be periodic with period one. If the signal A(t) is further assumed to be band-limited to a total of N harmonics, its AFT coefficients are given by:

$${a}_{k} ( {t}_{ref} ) = {\sum }_{m = 1}^{∞} {μ}_{1} ( m ) \cdot S ( mk , {t}_{ref} ) for k = 1 , 2 , 3 , … , N , \qquad ( 3 )$$

where each S(n,t_{ref}) denotes the output of a filter having the following filtering function, based on samples

$$A ( {t}_{ref} - \frac{j}{n} )$$

which are distributed at locations corresponding to respective Farey fractions of the interval 0 to 1:

$$S ( n , {t}_{ref} ) = \frac{1}{n} {\sum }_{j = 0}^{n - 1} A ( {t}_{ref} - \frac{j}{n} ) for n = 1 , 2 , 3 , … N . \qquad ( 4 )$$

Each of the filter outputs S(n,t_{ref}) is the sum of the respective samples

$$A ( {t}_{ref} - \frac{j}{n} )$$

multiplied by the scale factor 1/n, where t_{ref} is an arbitrary reference time. t_{ref} is preferably equal to 1 for a unit interval. Each AFT coefficient is the sum of the filter outputs of selected filters, weighted by the Mobius function μ₁(m).

To process a 2-D input signal such as an image or an image portion (e.g., a unit sub-image or block), the AFT is extended to two dimensions using a 2-D Mobius function μ₂(n,m) which is defined as follows:

μ₂(n,m)=μ₁(n)μ₁(m), (5)

where n and m are positive integers, and μ₁(n) is the 1-D Mobius function defined in Eqs. 2a, 2b, and 2c.

Formulae for the 2-D AFT of a zero-mean 2-D input signal A(p,q)—where p and q are continuous spatial coordinates in a unit range (i.e., a range from 0 to 1)—can be represented with respect to any arbitrary reference point (p_{ref}, q_{ref}) by a 2-D Fourier series as follows:

$$\begin{matrix}A ( {p}_{ref} , {q}_{ref} ) = {\sum }_{k = 1}^{∞} {\sum }_{l = 1}^{∞} {a}_{k , l} ( {p}_{ref} , {q}_{ref} ) & ( 6 ) \\ {a}_{k , i} ( {p}_{ref} , {q}_{ref} ) = {A}_{k , l} cos ( 2 π \cdot {kp}_{ref} + {θ}_{k} ) cos ( 2 π \cdot {lq}_{ref} + {θ}_{1} ) , & ( 7 )\end{matrix}$$

where (p_{ref}, q_{ref}) is an arbitrary reference location, preferably (1, 1) for a unit sub-image.

It is assumed that the signal A(p,q) is band-limited to N harmonics in both spatial dimensions p and q—i.e., the Fourier series coefficients higher than N are equal to zero. A filter-bank having N² filters is used to process the image data, each filter having the following filtering function:

$$S ( n , m , {p}_{ref} , {q}_{ref} ) = \frac{1}{n} \frac{1}{m} {\sum }_{j = 0}^{n - 1} {\sum }_{k = 0}^{m - 1} A ( {p}_{ref} - \frac{j}{n} , {q}_{ref} - \frac{k}{m} ) \qquad ( 8 )$$

where n=1, 2, . . . N and m=1, 2, . . . N. It can be seen from Eq. (8) that the spatial locations

$$( {p}_{ref} - \frac{j}{n} , {q}_{ref} - \frac{k}{m} )$$

of the samples

$$A ( {p}_{ref} - \frac{j}{n} , {q}_{ref} - \frac{k}{m} )$$

processed by the filters are defined—relative to the reference location (p_{ref}, q_{ref})—by respective Farey fractions j/m and k/m of the dimensions of a unit image block, as is discussed in further detail below with respect to FIG. 3.

By replacing the signal A(p,q) in Eq. (8) by its Fourier series given in Eqs. (6) and (7), it can be shown that the output of each filter is equal to the sum of a particular set of Fourier series coefficients of A(p,q):

$$\begin{matrix}S ( n , m , {p}_{ref} , {q}_{ref} ) = {\sum }_{j = j}^{∞} {\sum }_{l = 1}^{∞} {a}_{nj , mk} ( {p}_{ref} , {q}_{ref} ) \\ = {\sum }_{j such that n \vert j} {\sum }_{k such that m \vert k} {a}_{j , k} ( {p}_{ref} , {q}_{ref} )\end{matrix} \qquad ( 9 )$$

A derivation of Eq. (9) is provided in Appendix A attached hereto.

Based on the assumption that the signal is band-limited, there are no more than

$$⌊ \frac{N}{n} ⌋ + ⌊ \frac{N}{m} ⌋$$

terms that are non-zero, where └x┘ denotes the largest integer which is less than or equal to x. Given Eq. (9) it is possible to prove the following relation for the 2-D Fourier series coefficients (a proof is provided in Appendix B attached hereto):

$${a}_{k , l} ( {p}_{ref} , {q}_{ref} ) = {\sum }_{m = 1}^{∞} {\sum }_{n = 1}^{∞} {μ}_{2} ( m , n ) \cdot S ( mk , nl , {p}_{ref} , {q}_{ref} ) \\ for k , l = 1 , 2 , … N . \qquad ( 10 )$$

Furthermore, because of the close relationship between the DCT and the Discrete Fourier Transform (DFT), the above-described outputs from the 2-D AFT algorithm can be used to calculate the DCT coefficients of a unit sub-image divided into N×N uniformly spaced pixels. First, the image sensor array is divided into unit area blocks of pixels, each block having by definition, a size of 1×1. The photosensitive elements inside each unit area are placed in locations based on a set of Farey fractions of the unit block size, to provide the appropriate samples for the filters defined in Eq. (8). In order to calculate the filters' outputs, an appropriate reference location (p_{ref}, q_{ref}) is chosen. A convenient reference location is at p_{ref}=1 and q_{ref}=1 (at a corner of the unit area). Eq. (8) then becomes:

$$S ( n , m ) = \frac{1}{n} \frac{1}{m} {\sum }_{j = 0}^{n - 1} {\sum }_{k = 0}^{m - 1} A ( 1 - \frac{j}{n} , 1 - \frac{k}{m} ) \qquad ( 11 )$$

where n=1, 2, . . . N and m=1, 2, . . . N.

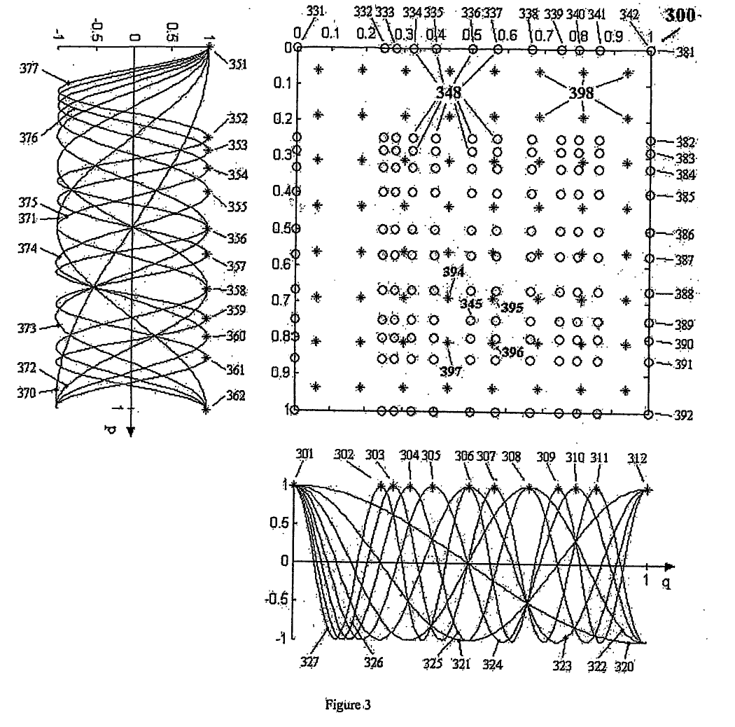

The output of the 2-D AFT is a set of 2-D Fourier series coefficients. In order to derive DCT coefficients from the Fourier Series coefficients, an extended image block X(p,q) is derived by extending the original image block A(p,q) by its own mirror image in both directions, as shown in FIG. 2, as follows:

$$X ( p , q ) = \{ \begin{matrix}A ( p , q ) 0 \leq p < 1 , 0 \leq q < 1 , \\ A ( 2 - p , q ) 1 \leq p < 2 , 0 \leq q < 1 , \\ A ( p , 2 - q ) 0 \leq p < 1 , 1 \leq q < 2 , \\ A ( 2 - p , 2 - q ) 1 \leq p < 2 , 1 \leq q < 2\end{matrix} \qquad ( 12 )$$

If the AFT is to be computed from extended image block X(p,q), rather than from the original block A(p,q), the appropriate filter values are:

$$S ( n , m ) = \frac{1}{n} \frac{1}{m} {\sum }_{j = 0}^{n - 1} {\sum }_{k = 0}^{m - 1} X ( 2 - \frac{2 * j}{n} , 2 - \frac{2 * k}{m} ) . \qquad ( 13 )$$

If the extended image block X(p,q) obeys the Nyquist criterion, the resulting AFT coefficients are equal to the DCT coefficients within a scale factor—a proof of this result is provided in Appendix C attached hereto. On the other hand, if the extended image does not satisfy the Nyquist criterion, the 2-D AFT coefficients are only an approximation of the 2-D DCT coefficients. This situation is more likely to occur for images rich in high-frequency components. However, it is possible to improve the approximation using aliasing correction techniques which are discussed in further detail below.

In any case, from Eqs. (12) and (13), the respective outputs S(n,m) of the filters can be expressed as follows:

$$S ( n , m ) = \frac{1}{n} \frac{1}{m} \cdot [ \begin{matrix}{\sum }_{j = 0}^{⌊ \frac{n}{2} ⌋} {\sum }_{k = 0}^{⌊ \frac{m}{2} ⌋} A ( \frac{2 j}{n} , \frac{2 k}{m} ) + {\sum }_{j = 0}^{⌊ \frac{n}{2} ⌋} {\sum }_{k = 1}^{⌈ \frac{m}{2} ⌉ - 1} A ( \frac{2 j}{n} , \frac{2 k}{m} ) + … \\ {\sum }_{j = 1}^{⌈ \frac{n}{2} ⌉ - 1} {\sum }_{k = 0}^{⌊ \frac{m}{2} ⌋} A ( \frac{2 j}{n} , \frac{2 k}{m} ) + {\sum }_{j = 1}^{⌈ \frac{n}{2} ⌉ - 1} {\sum }_{k = 1}^{⌈ \frac{m}{2} ⌉ - 1} A ( \frac{2 j}{n} , \frac{2 k}{m} )\end{matrix} ] , \qquad ( 14 )$$

where n and m take the values from 1 to N. ┌x┐ denotes the smallest integer which is greater than or equal to x.

From Eq. 14 it is apparent that there are certain points in the sample space that are repeated. As a result, by calculating the DCT rather than the DFT, the number of independent points in the 2-D AFT is decreased by nearly one-half. For example, to calculate an 8×8 point DCT inside the unit sub-image, a set of 12×12 photosensitive elements per unit area is used. The elements at the edges of the unit area are shared between adjacent sub-images, thus reducing the effective number of points per block to 11×11. An exemplary non-uniform sample space 300 is illustrated in FIG. 3. In the illustrated example, non-uniformly distributed sample points 348 are used for the 2-D AFT calculation. The corresponding effective DCT sample points 398 are distributed uniformly.

With the image sampled as illustrated in FIG. 3, and using filters whose filtering functions are defined according to Eq. (14), the 2-D AFT coefficients x_{k,1} can be computed as follows:

$$\begin{matrix}{x}_{k , l} = {\sum }_{m = 1}^{∞} {\sum }_{n = 1}^{∞} {μ}_{2} ( m , n ) \cdot S ( mk , nl ) for k , l = 1 , 2 , … N & ( 15 a ) \\ {x}_{k , 0} = {\sum }_{m = 1}^{∞} {μ}_{1} ( m ) \cdot S ( mk , N ) for k = 1 , 2 , … N & ( 15 b ) \\ {x}_{0 , 1} = {\sum }_{n = 1}^{∞} {μ}_{1} ( n ) \cdot S ( N , nl ) for 1 = 1 , 2 , … N & ( 15 c ) \\ {x}_{0 , 0} = E [ A ] , & ( 15 d )\end{matrix}$$

where E[A] is the mean value of the image, x_{k,l} are the 2-D AFT coefficients of the extended block image X, x_{k,n} are the coefficients obtained by calculating the 1-D AFT of the mean values of the rows along the p-axis, and x_{0,1} are the coefficients obtained by calculating the 1-D AFT of the mean values of the columns along the q-axis.
The corresponding DCT coefficients can be computed as follows:

DCT{A}(0,0)=8*E[A] (15e)

DCT{A}(k,0)=4√2*x_{k,0} k=1, 2, . . . N−1 (15f)

DCT{A}(0,l)=4√2*x_{0,l} l=1, 2, . . . N−1 (15g)

DCT{A}(k,l)=4*x_{k,l} k=1, 2, . . . N−1 and l=1, 2 . . . N−1 (15h)

The above discussion demonstrates that using the 2-D AFT to compute the DCT coefficients of an image portion allows the entire computation to be performed primarily with addition operations, and with very few multiplication operations, thus making the 2-D AFT procedure extremely efficient. The source of this increased efficiency can be further understood with reference to FIG. 3. The drawing illustrates an exemplary 2-D sample area 300 of a sensor array corresponding to the area of a conventional 8×8 block of pixels 398 arranged in a conventional pattern. However, in accordance with the present invention, the illustrated region 300 has certain preferred locations 348 for use with the above-described 2-D AFT technique. The preferred locations 348 correspond to extrema (i.e., maxima) of basis functions of the transform being performed. For example, it is well known that the basis functions of a Fourier transform are sine and cosine functions of various different frequencies (in the case of a time-varying signal) or wavelengths (in the case of a spatially varying signal such as an image). In the case of a cosine transform such as a DCT, the basis functions are cosine functions of various frequencies (for time-varying signals) or wavelengths (for spatially varying signals), as given by Eq. 1. In the exemplary sample area 300 illustrated in FIG. 3, columns 331, 332, 333, 334, 335, 336, 337, 338, 339, 340, 341, and 342 correspond to the locations of respective maxima 301, 302, 303, 304, 305, 306, 307, 308, 309, 310, 311, and 312 of cosine basis functions 320, 321, 322, 323, 324, 325, 326, and 327, where the spatial coordinate q of these basis functions is defined according to the spatial coordinate system of either the sensor array or the illustrated region 300. In particular, in the illustrated example, the spatial coordinate q of the aforementioned basis functions 320, 321, 322, 323, 324, 325, 326, and 327 is equal to the horizontal coordinate of the sensor array, referenced to the left edge (column 331) of the illustrated region 300. Similarly, rows 381, 382, 383, 384, 385, 386, 387, 388, 389, 390, 391, and 392 of the preferred sample locations 348 correspond to respective extrema 351, 352, 353, 354, 355, 356, 357, 358, 359, 360, 361, and 362 of cosine basis functions 370, 371, 372, 373, 374, 375, 376, and 377, these basis functions having a vertical spatial coordinate p which, similarly to q, is defined according to the spatial coordinate system of either the sensor array or the illustrated region 300 thereof.

The 2-D AFT calculation uses only selected samples such that, for each selected sample, the relevant basis function has a value of +1 at the location of the sample. Such a sampling pattern allows the simplifying assumption that, when computing the AFT coefficients x_{k,l}, the pre-scaled input sensor signals need only be multiplied by a factor of +1, 0 or −1—hence the use of the 2-D Mobius function μ₂ (m,n) in Eq. (10).

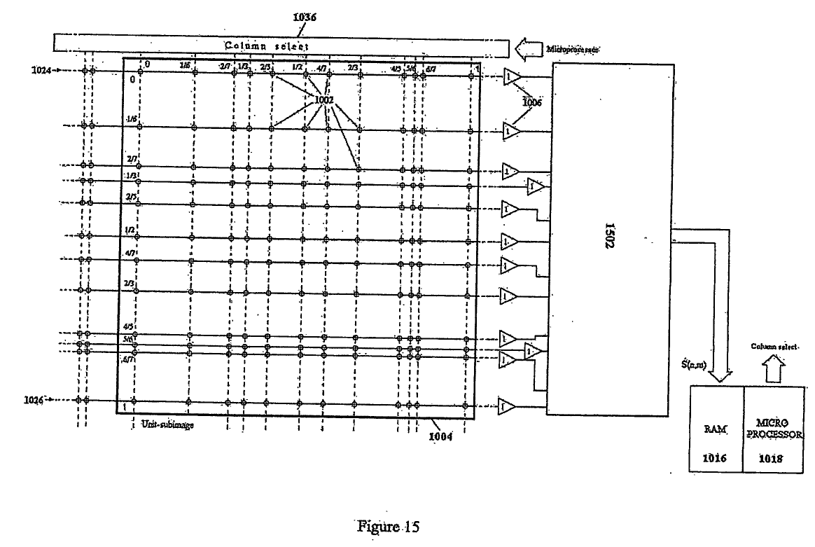

FIG. 10 illustrates an exemplary portion 1004 of a sensor array 1034, along with a filter arrangement 1022 for detecting an incoming signal (e.g., a light pattern being received from a scene being imaged) and processing the signal to derive the respective filter outputs S(n,m) in Eq. (14). The sensor array portion 1004 has sensors 1002 located in the preferred locations for the AFT calculation, these locations being defined to have vertical and horizontal distances, relative to corner pixel 1028, which are equal to various Farey fractions multiplied by the size 1032 of the array portion 1004. Optionally, the filtering can be performed by an analog circuit 1022 as is illustrated in FIG. 10 or by a digital filter 1502 as is illustrated in FIG. 15. In either case, column selection operations are preferably performed by a column selector 1036 under control of a microprocessor 1018, and the respective filter outputs S(n,m) are stored in a memory device such as RAM 1016.

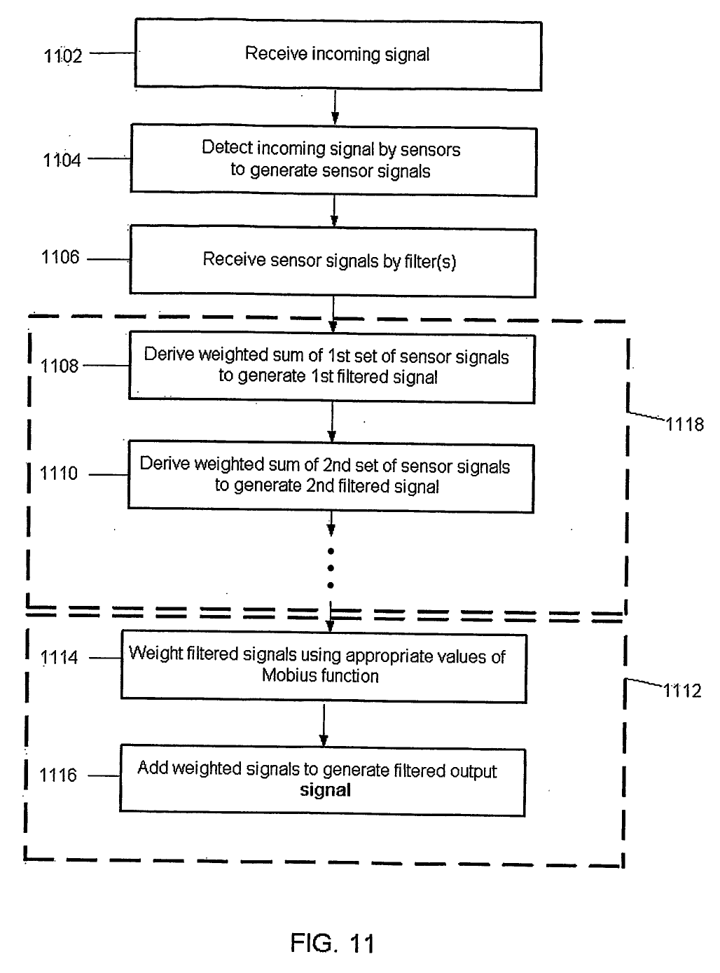

Regardless of whether an analog filter 1022 or a digital filter 1502 is being used to compute the filter outputs S(n,m), the illustrated arrangement can be operated according to the exemplary procedure illustrated in FIG. 11. In the illustrated procedure, an incoming signal—e.g., a light pattern from a scene—is received by the sensor array 1004 (step 1102). The incoming signal is detected by the respective sensors 1002 of the array 1004 to generate sensor signals (step 1104), and the signals are received by the analog or digital filter arrangement 1022 or 1502 (step 1106). Respective weighted sums of respective sets of sensor signals are derived to generate respective filtered signals (step 1118). For example, a weighted sum of a set of sensor signals (e.g., a weighted sum of the respective pixel values 1028, 1029, 1030, and 1031 from the intersections of the rows 1024 and 1026 with the columns 1044 and 1046) is derived by the filter 1022 or 1502 to generate a filtered signal S(2,3) (step 1118).

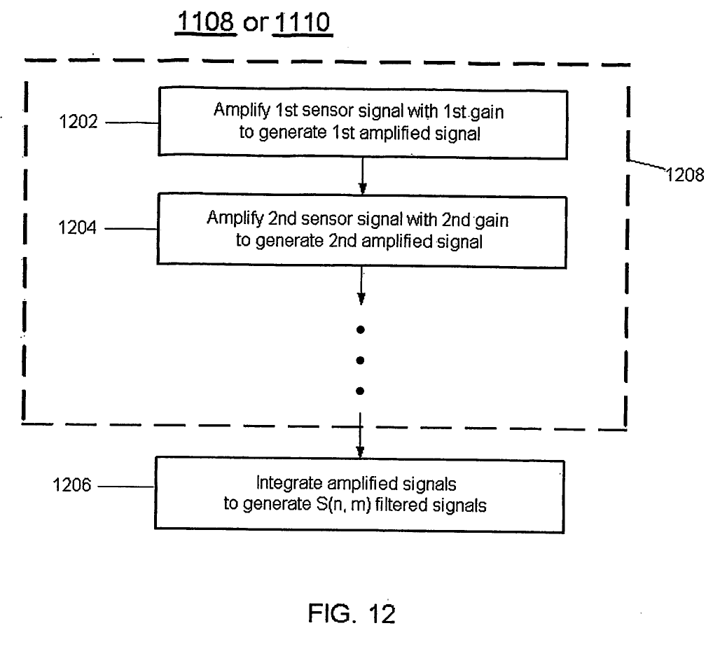

In the case of an analog filter arrangement 1022, the weighted sums derived in steps 1108 and 1110 can be produced in accordance with the procedure illustrated in FIG. 12. In the illustrated filtering procedure 1108 or 1110, the signals from the respective sensors are amplified with the appropriate gains to generate respective amplified signals (step 1208). For example, the signal from the first sensor 1028 in row 1024 and column 1044 is amplified with a first gain to generate a first amplified signal (step 1202), the signal from the second sensor 1029 in the row 1024 and column 1046 is amplified with a second gain to generate a second amplified signal (step 1204), etc. The resulting amplified signals are integrated to generate the filtered signal (step 1206).

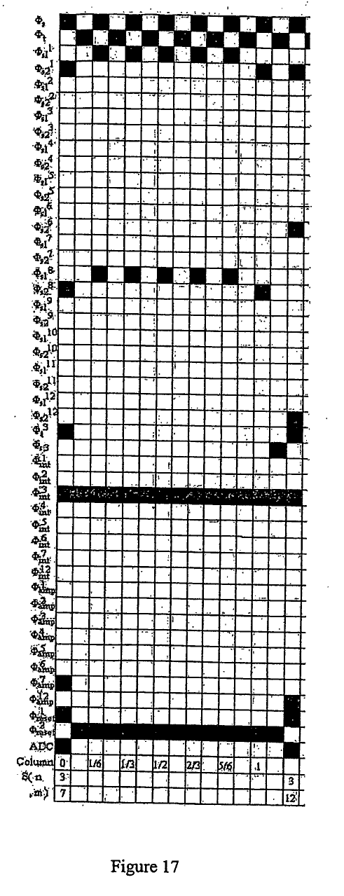

The operation of the analog filtering circuit 1022 illustrated in FIG. 10 can be further understood with reference to the timing diagram illustrated in FIG. 17. First, the microprocessor 1018 determines which filter is to be calculated—i.e., selects values for n and m. Given the value m, the appropriate columns and Φ^{m}ₐₘₚ are selected. Then, given the value of n, appropriate Φⁿᵢₙₜ and Φⁱₛⱼ are selected. An exemplary timing cycle for calculating the filter S(3,12) is as follows:
1. n=3, m=12,
2. Φ³ᵢₙₜ=1, Φⁱᵢₙₜ=0 where i=1, 2, 4, 5, 6, 7, 12,
3. Select Column 0
4. Φ¹ₛ₂=1, Φ⁸ₛ₂=1, other Φⁱₛⱼ=0
5. Transfer charge to integrator 1010, Φₜ=1, Φⁱₛⱼ=0
6. Select Column 1/6
7. Φ¹ₛ₁=1, Φ⁸ₛ₁=1, other Φⁱₛⱼ=0
8. Transfer charge to integrator 1010, Φₜ=1, Φⁱₛⱼ=0
9. Select Column 1/3
10. Φ¹ₛ₁=1, Φ⁸ₛ₁=1, other Φⁱₛⱼ=0
11. Transfer charge to integrator 1010, Φₜ=1, Φⁱₛⱼ=0
12. Select Column 1/2
13. Φⁱₛ₁=1, Φ⁸ₛ₁=1, other Φⁱₛⱼ=0
14. Transfer charge to integrator 1010, Φₜ=1, Φⁱₛⱼ=0
15. Select Column 2/3
16. Φ¹ₛ₁=1, Φ⁸ₛ₁=1, other Φⁱₛⱼ=0
17. Transfer charge to integrator 1010, Φₜ=1, Φⁱₛⱼ=0
18. Select Column 5/6
19. Φ¹ₛ₁=1, Φ⁸ₛ₁=1, other Φⁱₛⱼ=0
20. Transfer charge to integrator 1010, Φₜ=1, Φⁱₛ₁=0
21. Sample the integrator's output, Φₛ₃=1
22. Φ¹²ₐₘₚ=1, Φⁱₐₘₚ=0, where i=1, 2, 3, 4, 5, 6, 7,
23. Transfer charge to amplifier 1012, Φₛ₃=0, Φₜ₃=1
24. Perform AD conversion using ADC 1014 and store the digital value S(3,12) in RAM 1016
25. Reset the integrator 1010 and amplifier 1012

Once the respective filter outputs S(m,n) are derived, the 2-D AFT coefficients are derived (step 1112). To derive the AFT coefficients (step 1112), the filter outputs are weighted using appropriate values of the Mobius function as is described above with respect to Eqs. (15a)-(15d) above (step 1114), and the resulting weighted signals are added/summed in accordance with Eqs. (15a)-(15d) (step 1116).

It is to be noted that, if a digital filter 1502 is used, as is illustrated in FIG. 15, the respective signals from the sensors 1002 in the array 1004 are preferably amplified by amplifiers 1006, and the resulting amplified signals are then received (converted to digital values) and processed by the digital filter 1502. Those skilled in the art will be familiar with numerous commercially available, individually programmable, special-purpose digital filters which can easily be programmed by ordinarily skilled practitioners to perform the mathematical operations described above. Because the resolution of the analog-to-digital converter (ADC) 1014 in a typical image sensor system is no greater than 12 bits, a 16-bit digital signal processor is suitable for use as the digital filter 1502.

The 2-D AFT is based on the assumption that the mean intensity value (a/k/a the “DC” value) of the full sub-image, as well as mean value for each row and column separately, is zero. If there is a non-zero DC value for a row, column, or the entire sub-image, that value is preferably used to derive correction values for adjusting the appropriate filter outputs S(n,m). The proper correction amounts for the case when the entire sub-image has a non-zero mean E[A], are as follows:

$$\begin{matrix}Δ ( k , 0 ) = - E [ A ] ( {\sum }_{m = 1}^{⌊ \frac{N}{k} ⌋} {μ}_{1} ( m ) ) k = 1 , 2 … N - 1 ; \\ Δ ( 0 , l ) = - E [ A ] ( {\sum }_{m = 1}^{⌊ \frac{N}{l} ⌋} {μ}_{1} ( m ) ) l = 1 , 2 … N - 1 \\ and & ( 16 a ) \\ Δ ( k , l ) = - E [ A ] ( {\sum }_{m = 1}^{⌊ \frac{N}{k} ⌋} {μ}_{1} ( m ) ) ( {\sum }_{n = 1}^{⌊ \frac{N}{l} ⌋} {μ}_{1} ( n ) ) k , l = 1 , 2 … N - 1. & ( 16 b )\end{matrix}$$

In addition, correction amounts should be computed if the input signal has non-zero mean values in any of the rows or columns (i.e., if x_{k,0} or x_{0,1} are non-zero). In the case of non-zero mean values in rows or columns, it is sufficient to correct only x_{k,l}, where k=1, 2, . . . . N−1 and l=1, 2 . . . . N−1. The correction formula is as follows:

$${Δ}_{local} ( k , l ) = - {x}_{k , 0} ( {\sum }_{m = 1}^{⌊ \frac{N}{1} ⌋} {μ}_{1} ( m ) ) - {x}_{0 , l} ( {\sum }_{m = 1}^{⌊ \frac{N}{k} ⌋} {μ}_{1} ( m ) ) \qquad ( 17 )$$

The correction factors Δ(k,l) and Δ_{local}(k,l) are then added to the uncorrected 2-D AFT coefficients x_{k,l} to derive corrected 2-D AFT coefficients A_{c}(k,l) as follows:

A_{c}(k,l)=x_{k,l}+Δ(k,l) k=0, l=1, 2 . . . . N−1 or k=1, 2 . . . N−1, l=0 (18a)

A_{c}(k,l)=x_{k,l}+Δ(k,l)+Δ_{local}(k,l) k,l=1, 2 . . . . N−1 (18b)

As an illustrative example, the 8×8 DCT case will now be considered. It is not necessary to determine exactly the respective mean values of the entire unit-area sub-image and of the local rows and columns. Rather, it is sufficient to use estimates for these mean values. For the mean value E[A] of the entire sub-image A, the closest estimate, in terms of least mean-square error, is provided by the filter output that averages the largest number of points. In the general, N×N case this is S(N,N). In the case of an 8×8 DCT, the best estimate of the mean E[A] of the entire sub-image A is as follows:

$$E [ A ] = S ( 8 , 8 ) = \frac{1}{64} [ \begin{matrix}{\sum }_{j = 0}^{4} {\sum }_{k = 0}^{4} A ( \frac{j}{4} , \frac{k}{4} ) + {\sum }_{j = 0}^{4} {\sum }_{k = 1}^{3} A ( \frac{j}{4} , \frac{k}{4} ) + \\ {\sum }_{j = 1}^{3} {\sum }_{k = 0}^{4} A ( \frac{j}{4} , \frac{k}{4} ) + {\sum }_{j = 1}^{3} {\sum }_{k = 1}^{3} A ( \frac{j}{4} , \frac{k}{4} )\end{matrix} ] \qquad ( 19 )$$

For the 8×8 DCT case, the resulting global DC correction values for each 2-D AFT coefficient—based on Eqs. 16a and 16b—are provided in Table 1:

TABLE 1

| 1 | | | | |
|---|---|---|---|---|
| k | 0 | 1 | 2 | 3 |
| 0 | 0 | 2 * E[A] | E[A] | 0 |
| 1 | 2 * E[A] | −4 * E[A] | −2 * E[A] | 0 |
| 2 | E[A] | −2 * E[A] | −E[A] | 0 |
| 3 | 0 | 0 | 0 | 0 |
| 4 | 0 | 0 | 0 | 0 |
| 5 | −E[A] | 2 * E[A] | E[A] | 0 |
| 6 | −E[A] | 2 * E[A] | E[A] | 0 |
| 7 | −E[A] | 2 * E[A] | E[A] | 0 |

| | | | | |
|---|---|---|---|---|
| 1 | | | | |
| k | 4 | 5 | 6 | 7 |

| | | | | |
|---|---|---|---|---|
| 0 | 0 | −E[A] | −E[A] | −E[A] |
| 1 | 0 | 2 * E[A] | 2 * E[A] | 2 * E[A] |
| 2 | 0 | E[A] | E[A] | E[A] |
| 3 | 0 | 0 | 0 | 0 |
| 4 | 0 | 0 | 0 | 0 |
| 5 | 0 | −E[A] | −E[A] | −E[A] |
| 6 | 0 | −E[A] | −E[A] | −E[A] |
| 7 | 0 | −E[A] | −E[A] | −E[A] |

The correction values for each 2-D AFT coefficient when there are non-zero column means and/or row means are provided in Table 2:

TABLE 2

| 1 | | | | | | | |
|---|---|---|---|---|---|---|---|
| k | 1 | 2 | 3 | 4 | 5 | 6 | 7 |
| 1 | 2x_{0, 1} + 2x_{1, 0} | 2x_{0, 2} + x_{1, 0} | 2x_{0, 3} | 2x_{0, 4} | 2x_{0, 5} − x_{1, 0} | 2x_{0, 6} − x_{1, 0} | 2x_{0, 7} − x_{1, 0} |
| 2 | x_{0, 1} + 2x_{2, 0} | x_{0, 2} + x_{2, 0} | x_{0, 3} | x_{0, 4} | x_{0, 5} − x_{2, 0} | x_{0, 6} − x_{2, 0} | x_{0, 7} − x_{2, 0} |
| 3 | 2x_{3, 0} | x_{3, 0} | 0 | 0 | −x_{3, 0} | −x_{3, 0} | −x_{3, 0} |
| 4 | 2x_{4, 0} | x_{4, 0} | 0 | 0 | −x_{4, 0} | −x_{4, 0} | −x_{4, 0} |
| 5 | −x_{0, 1} + 2x_{5, 0} | −x_{0, 2} + x_{5, 0} | −x_{0, 3} | −x_{0, 4} | −x_{0, 5} − x_{5, 0} | −x_{0, 6} − x_{5, 0} | −x_{0, 7} − x_{5, 0} |
| 6 | −x_{0, 1} + 2x_{6, 0} | −x_{0, 2} + x_{6, 0} | −x_{0, 3} | −x_{0, 4} | −x_{0, 5} − x_{6, 0} | −x_{0, 6} − x_{6, 0} | −x_{0, 7} − x_{6, 0} |
| 7 | −x_{0, 1} + 2x_{7, 0} | −x_{0, 2} + x_{7, 0} | −x_{0, 3} | −x_{0, 4} | −x_{0, 5} − x_{7, 0} | −x_{0, 6} − x_{7, 0} | −x_{0, 7} − x_{7, 0} |

Given the 2-D AFT coefficients x_{k,l} of the extended sub-image X and the corrected AFT coefficients A_{c}(k,l), the DCT coefficients of the sub-image A can be calculated. The relations between the respective 8×8 point DCT coefficients DCT(k,1) and the corresponding corrected 2-D AFT coefficients A_{c}(k,1) are provided in Table 3:

TABLE 3

| 1 | | | | | | | | |
|---|---|---|---|---|---|---|---|---|
| k | 0 | 1 | 2 | 3 | 4 | 5 | 6 | 7 |
| 0 | A_{c}(8, 8) * 8 | A_{c}(0, 1) * 4√2 | A_{c}(0, 2) * 4√2 | A_{c}(0, 3) * 4√2 | A_{c}(0, 4) * 4√2 | A_{c}(0, 5) * 4√2 | A_{c}(0, 6) * 4√2 | A_{c}(0, 7)*4√2 |
| 1 | A_{c}(1, 0) * 4√2 | A_{c}(1, 1) * 4 | A_{c}(1, 2) * 4 | A_{c}(1, 3) * 4 | A_{c}(1, 4) * 4 | A_{c}(1, 5) * 4 | A_{c}(1, 6) * 4 | A_{c}(1, 7) * 4 |
| 2 | A_{c}(2, 0) * 4√2 | A_{c}(2, 1) * 4 | A_{c}(2, 2) * 4 | A_{c}(2, 3) * 4 | A_{c}(2, 4) * 4 | A_{c}(2, 5) * 4 | A_{c}(2, 6) * 4 | A_{c}(2, 7) * 4 |
| 3 | A_{c}(3, 0) * 4√2 | A_{c}(3, 1) * 4 | A_{c}(3, 2) * 4 | A_{c}(3, 3) * 4 | A_{c}(3, 4) * 4 | A_{c}(3, 5) * 4 | A_{c}(3, 6) * 4 | A_{c}(3, 7) * 4 |
| 4 | A_{c}(4, 0) * 4√2 | A_{c}(4, 1) * 4 | A_{c}(4, 2) * 4 | A_{c}(4, 3) * 4 | A_{c}(4, 4) * 4 | A_{c}(4, 5) * 4 | A_{c}(4, 6) * 4 | A_{c}(4, 7) * 4 |
| 5 | A_{c}(5, 0) * 4√2 | A_{c}(5, 1) * 4 | A_{c}(5, 2) * 4 | A_{c}(5, 3) * 4 | A_{c}(5, 4) * 4 | A_{c}(5, 5) * 4 | A_{c}(5, 6) * 4 | A_{c}(5, 7) * 4 |
| 6 | A_{c}(6, 0) * 4√2 | A_{c}(6, 1) * 4 | A_{c}(6, 2) * 4 | A_{c}(6, 3) * 4 | A_{c}(6, 4) * 4 | A_{c}(6, 5) * 4 | A_{c}(6, 6) * 4 | A_{c}(6, 7) * 4 |
| 7 | A_{c}(7, 0) * 4√2 | A_{c}(7, 1) * 4 | A_{c}(7, 2) * 4 | A_{c}(7, 3) * 4 | A_{c}(7, 4) * 4 | A_{c}(7, 5) * 4 | A_{c}(7, 6) * 4 | A_{c}(7, 7) * 4 |

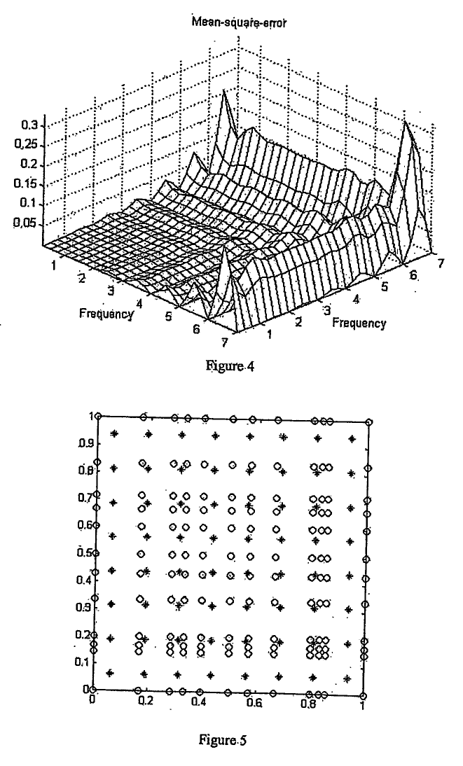

If the image signal being sampled has high spatial-frequency components that are not integer multiples of the unit spatial frequency, aliasing is likely to introduce a certain amount of error into the DCT coefficients computed with the AFT algorithm. For example, as is illustrated in FIG. 2, there are sub-image boundaries 204 within the extended sub-image 202 derived from the original sub-image 102. At each of these boundaries there is likely to be a discontinuity in the first derivative of the pixel intensity. The discontinuities tend to increase as the input signal frequency approaches half the Nyquist sampling frequency. The discontinuities also tend to increase as the phase of the input signal approaches π/2. If substantial discontinuities are present, the extended sub-image 202 will have significant Fourier components at frequencies greater than half the Nyquist frequency. It is well known that if the Nyquist criterion is violated due to undersampling of an image signal or other signal, the high frequency harmonics—i.e., the components violating the Nyquist criterion—“fold back” to appear at frequencies below half the Nyquist frequency. An image extension, as such shown in FIG. 2, does not lead to aliasing effects if the input signal is uniformly sampled at steps of ⅛th of the unit interval. However, due to the non-uniform placement of samples which have locations based on Farey fractions as is discussed above, aliasing errors may arise in DCT coefficients computed based on the AFT. The mean-square-error between uniformly sampled input signal values and an approximation of this signal—where the approximation is computed by taking the inverse DCT of the AFT-based DCT coefficients—provides an indication of the accuracy of the AFT-based procedure. The amount of error can be significant when processing image signals which have substantial high-frequency content. Exemplary results for mean-square error as a function of frequency are illustrated in FIG. 4, which plots, as a function of frequency, the mean-square error of the approximation signal obtained by taking the inverse DCT of the exemplary DCT coefficients derived by the above-described AFT technique. The illustrated results demonstrate that the error is greatest in the high-frequency components.

Error caused by undersampling not only directly affects the accuracy of filter outputs S(n,m) before any DC correction is applied, but also affects the accuracy of the DC correction itself.

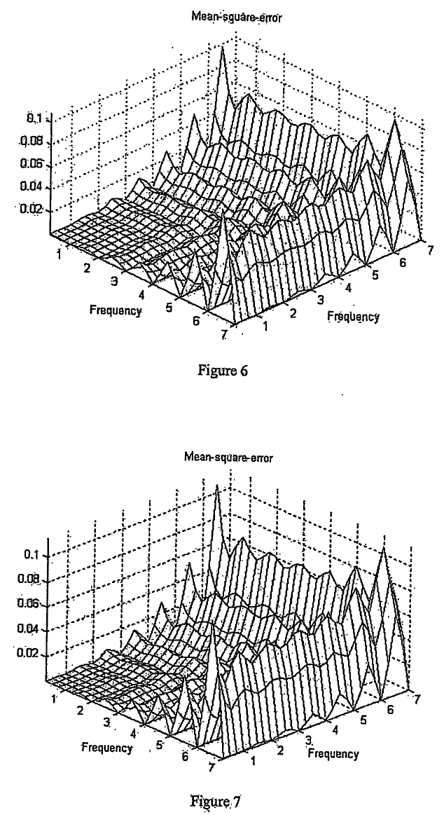

An improved estimate for the mean value of the image may be obtained from the output of a filter, S, that averages a set of points taken at a spatial frequency that is not expected to be present in the spectrum of the extended image X—P. Paparao, A. Ghosh, “An Inproved Arithmetic Fourier Transform Algorithm,” SPIE Vol. 1347 Optical Information-Processing Systems and Architectures II (1990). As a conclusion of the aforementioned paper, the increase in the order of the filter S, used to calculate the mean value, may improve the mean value estimate. Thus, the mean-square error should decrease when filters of order higher than 8 are used to estimate the mean value in the above-described 8×8 DCT case. The density and the number of photosensitive elements that are averaged increases, when the higher order filters are used, so one should choose a filter with the highest realizable order, as limited by the fabrication technology. A particular fabrication technology limits the smallest distance between photosensitive elements, thus limiting the highest realizable filter order. In order to not significantly increase the number of photosensitive elements, the order of the filter should be divisible by at least one lower order. If the order of the filter is divisible by the lower order, the Farey fractions of the lower order filter would match to a subset of Farey fractions associated with a higher order filter, thus the number of additional photo-sensitive elements would not increase substantially. A typical example is the filter S(12,12), where 12 is divisible by 2, 3, 4, 6. A filter of order 12 requires no greater number of photosensitive elements than does a filter of order 8. However, for a 12^{th}-order filter, the photosensitive elements are preferably more densely packed in certain parts of the sub-image, as is illustrated in FIG. 5. In general, in an N^{th}-order filter, sample locations may be placed at positions 2j/N, where j=0, 1, . . . N/2. The estimated mean-square-error, where filters of order 12 are used to estimate the global and local mean values, is shown in FIG. 6.

Optionally, photosensitive elements located at the exact Farey fraction locations can be used to obtain the sample values for the high-order filter computations used to estimate the global and local DC values. Alternatively, or in addition, the sample values can be obtained by interpolation of neighboring samples using interpolation procedures discussed in further detail below. Furthermore, filters of order higher than 12 may be used to estimate the DC values. However, there is a tradeoff associated with using higher-order filters: such filters may entail an increase in the number of photosensitive elements and/or a decrease of the spacing between the elements. Moreover, increasing the order of the filters beyond a value of 12 typically does not provide significant additional benefit. For example, FIG. 7 illustrates the mean-square error of a system which uses filters of order 16 to estimate the global and local DC values. A visual comparison of FIGS. 6 and 7 reveals that the error is approximately the same in both cases. It is therefore apparent that filters of order 12 provide a better tradeoff between the number of sample points (or pixel density) and the overall accuracy.

Aliasing errors in the non-DC-corrected filter outputs can be reduced by introducing additional pixels into the sensor array, provided that the fabrication technology allows for a sufficiently dense pixel distribution. To correct for such aliasing, AFT coefficients of order higher than the equivalent uniform sampling frequency (i.e. coefficients of order higher than 8 for the 8×8 DCT case) can be used to correct the lower-order coefficients. The higher-order coefficients can be obtained directly from supplemental Farey-fraction-spaced sensors, interpolated from neighboring pixels, or can be estimated as a fraction of the lower-order coefficients—methods which are described in further detail below.

By introducing additional pixels at the precise Farey fraction locations, it is possible to calculate the higher-order AFT coefficients exactly, which then may be used to correct the lower-order AFT coefficients. For example, if M is the number of DCT coefficients, and the highest realizable order of the Farey fraction space is N, where N>M—i.e. N=9, 10, 11, 12, . . . for M=8. First, the global and local DC corrections Δ(k,l) and Δ_{local}(k,l) are estimated using the highest order (N) filters as described above, and are added to the uncorrected AFT coefficients x_{k,l} as is indicated in Eqs. (18a) and (18b), above. The resulting DC-corrected AFT coefficients A_{c}(k,l), where k,l=0, 1, 2 . . . N−1, are used to determine the aliasing-correction values:

Δₐₗᵢₐₛ(k,l)=−A_{c}(k,2M−1) k=0, 1, . . . 2M−N; l=0, 1, . . . 2M−N (20a)

Δₐₗᵢₐₛ(k,l)=−A_{c}(k,2M−1) k=0, 1, . . . 2M−N; l=2M−N+1, . . . M−1 (20b)

Δₐₗᵢₐₛ(k,l)=−A_{c}(2M−k,l) k=2M−N+1, . . . M−1; l=0, 1, . . . 2M−N (20c)

Δₐₗᵢₐₛ(k,l)=−A_{c}(k,2M−1)−A_{c}(2M−k,l)+A_{c}(2M−k,2M−1) k=2M−N+1, . . . M−1; l=2M−N+1, . . . M−1 (20d)

The correction formulae in Eqs. (20a)-(20d) are valid when M is an even number—which is usually the case—and 2M is greater then N. Aliasing-corrected 2-D AFT coefficients A_{cc}(k,l) can then be calculated by adding the above-listed aliasing-correction values to the DC-corrected AFT values A_{c}(k,l):

A_{cc}(k,l)=A_{c}(k,l)+Δₐₗᵢₐₛ(k,l) k=0, 1, . . . M−1; l=0, 1, . . . . M−1 (21)

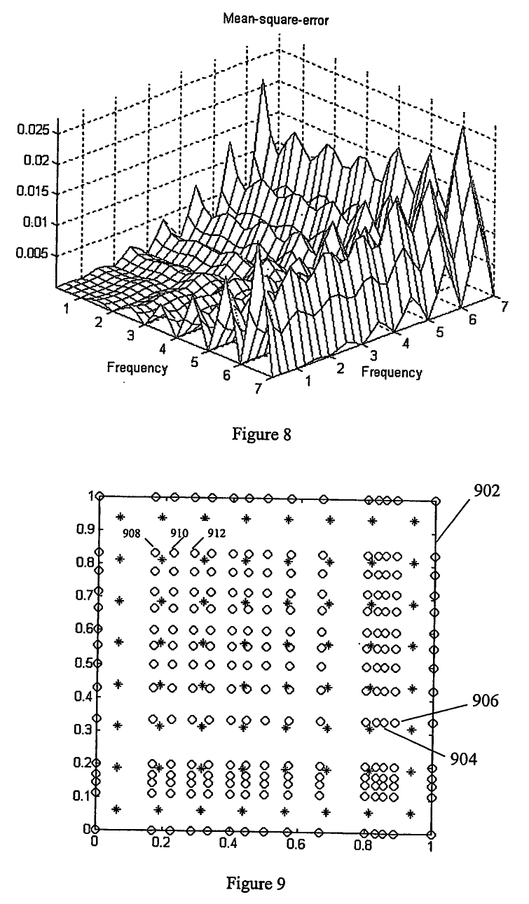

FIG. 8 illustrates the estimated mean-square error in an exemplary case in which higher Farey fraction samples are used to correct for aliasing. In the illustrated example, a Farey fraction sample space of order 12 (i.e., N=12) has been used to provide the pixel values, filters of order 12 have been used to estimate global and local DC values and higher-order AFT coefficients (coefficients of order 8, 9, 10, and 11) have been used to correct for aliasing as is discussed above with respect to Eqs. (20a)-(20d). In this example, the maximum estimated mean-square-error is at frequency (6.5,6.5) and is equal to 0.0273.

In FIGS. 4 and 6-8, the estimated mean-square errors were derived by assuming for each frequency point (f₁, f₂) that the input image X is a 2-D cosine with frequency (f₁/2, f₂/2). The 2-D AFT based 2-D DCT coefficients were calculated for such an input, and then an inverse 2-D DCT was calculated to obtain image Y. The mean-square error between image Y and X was calculated and assigned to the frequency point (f₁, f₂).

The preferred number of image samples to be used for the AFT computation tends to increase substantially as the order of the Farey fraction space is increased. For example a total of 46 photosensitive elements per unit interval should be used when N=12. It may be impractical or expensive to fabricate image sensors with such a high pixel density, in which case the higher AFT coefficients are preferably estimated by interpolation of adjacent pixels. The Farey sampling points to be used for filters of order M,M+1, . . . N−1 can be interpolated either from the available set of samples or from the set of samples being processed by a particular filter, preferably the highest order filter N (the 12th-order filter in the example given above). In any case, an exemplary interpolation system is discussed in further detail below.

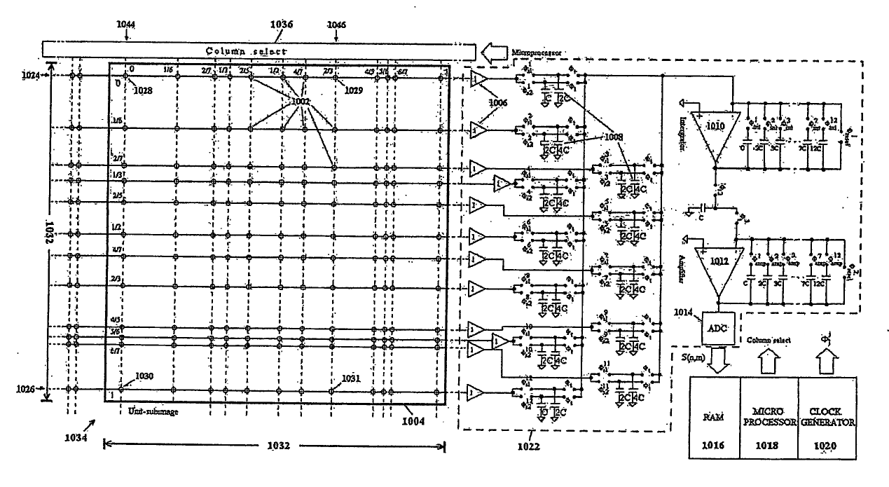

In an additional method for calculating higher-order 2-D AFT coefficients (e.g., coefficients of order 8, 9, 10, and 11), the higher-order coefficients are calculated as a fraction of the neighboring higher-order coefficients. Specifically, one or more higher-order coefficients are first calculated using exact Farey sampling points, and the other higher-order coefficients can be estimated from these exact values as follows. Assuming that the image A is band-limited and has no frequency components beyond half the Nyquist frequency, the correlation between respective neighboring, higher-order Fourier series coefficients is typically quite high. Moreover, simulations have shown that even Fourier series coefficients (coefficients 8, 10, 12 in our example) tend to be highly correlated with each other, and similarly, odd Fourier series coefficients (coefficients 9 and 11 in our example) tend to be highly correlated with each other. Accordingly, if one even, higher-order Fourier coefficient is known, the other even, higher-order coefficients can be estimated. Similarly, if one odd, higher-order Fourier coefficient is known, the other odd, higher-order coefficients can be estimated. For example, if a Farey fraction space of order 7 and filters of order 12 are used, filters of order 9 can be used to estimate the odd higher-order coefficients, and filters of order 12 can be used to estimate the even higher-order coefficients. An exemplary sample space suitable for such estimations (for aliasing-correction) is illustrated in FIG. 9, where locations of the photosensitive elements are defined as Farey fractions 2j/n; j=0, 1, 2 . . . n−1 and n=1, 2, 3, 4, 5, 6, 7, 9, and 12.

In addition, a single system can combine the above-described techniques of: (a) adding sensors at higher-order Farey fraction locations, and (b) interpolating the values from existing sensors to estimate the values of the incoming signal at the appropriate higher-order locations. For example, as is illustrated in FIG. 9, if a desired higher-order pixel location 906 is quite close to a lower-order pixel location 904, and there is a sensor at the lower-order location 904, it may be preferable to compute an estimated value for the higher-order pixel 906 by interpolation, rather than by placing a sensor at the higher-order location 906. However, if a desired higher-order location 910 is farther away from the nearest lower-order pixels 908 and 912, it may be preferable to add an extra sensor to the sensor array in the higher-order location 910.

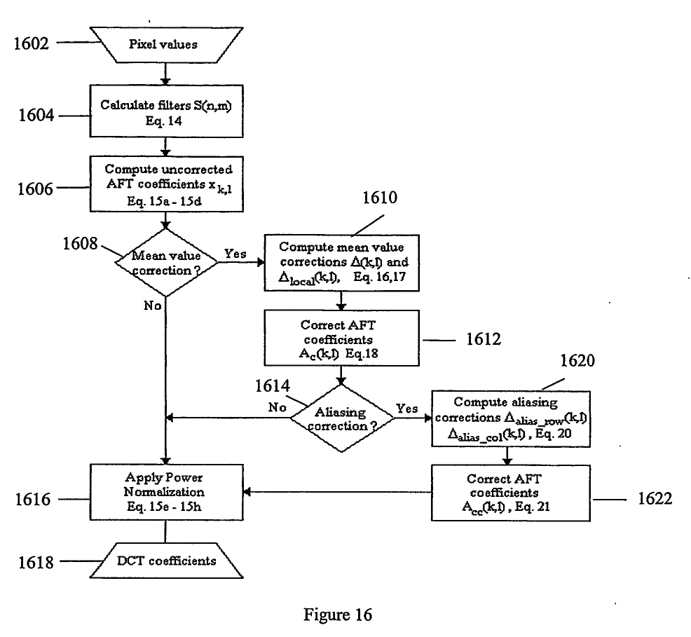

FIG. 16 provides an overview of an exemplary procedure for image sensing and processing in accordance with the present invention. Pixel values 1602 are processed to calculate the filters S(n,m) according to Eq. (14) above (step 1604). A set of uncorrected AFT coefficients x_{k,l} are computed based upon the filter values S(n,m) (step 1606). If the entire image and the respective rows and columns have no non-zero DC components, no mean value correction is required (step 1608). The AFT coefficients x_{k,l} are therefore power-normalized as is illustrated above in Eqs. (15e)-(15h)—to derive the DCT coefficients 1618 (step 1616). If, however, a mean value correction is appropriate (step 1608) the mean value correction amounts are computed (step 1610) and used to correct the AFT coefficients x_{k,l} for deriving corrected coefficients A_{c}(k,l) (step 1612). If no aliasing correction is required (step 1614), the procedure continues to step 1616. However, if aliasing correction is appropriate (step 1614), the aliasing corrections are computed as discussed above (step 1620), and used to further correct the DC-corrected AFT coefficients A_{c}(k,l) for deriving alias-corrected coefficients A_{cc}(k,l) (step 1622). The DCT coefficients 1618 are then calculated based on the alias-corrected AFT coefficients A_{cc}(k,l) (step 1616).

As is discussed above, interpolation of measurements from neighboring sensors in a sensor array can be useful for estimating the value of a pixel adjacent to the locations of the sensors. For example, referring to the unit area 300 illustrated in FIG. 3, if the AFT method of the present invention is to be used with a conventional sensor array having sensors located in uniformly spaced positions 398, interpolation can be used to estimate the values of the image at the Farey-fraction-based locations 348. If the computation is being performed by a digital signal processor such as the digital filter 1502 illustrated in FIG. 15, the computation of the value at a particular Farey fraction location 345 can, for example, be performed by computing an average of the respective values generated by the sensors located at the nearest uniformly spaced locations 394, 395, 396, and 397.

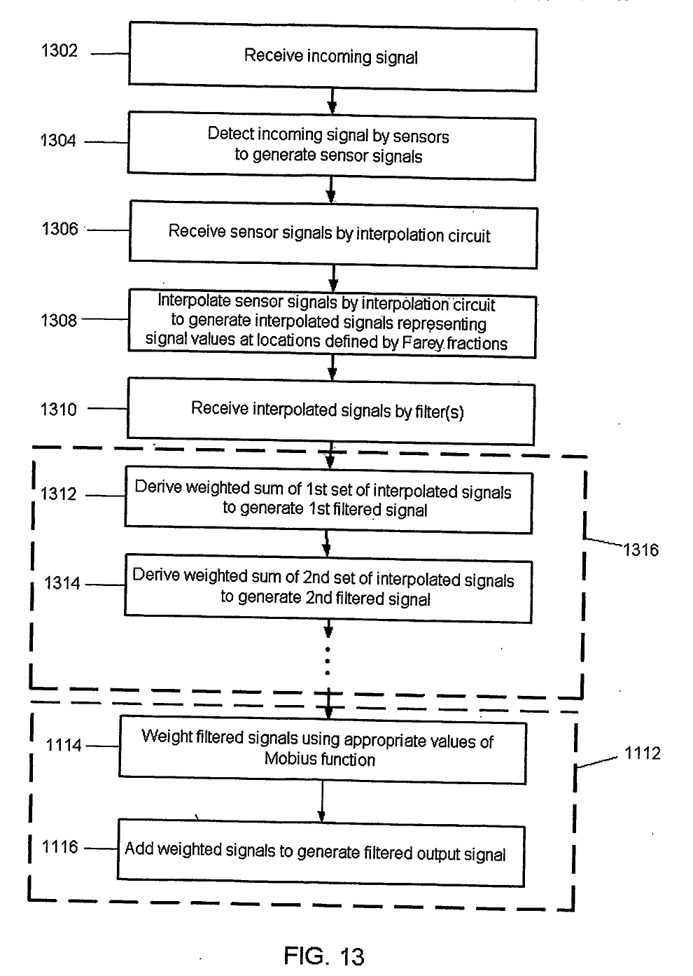

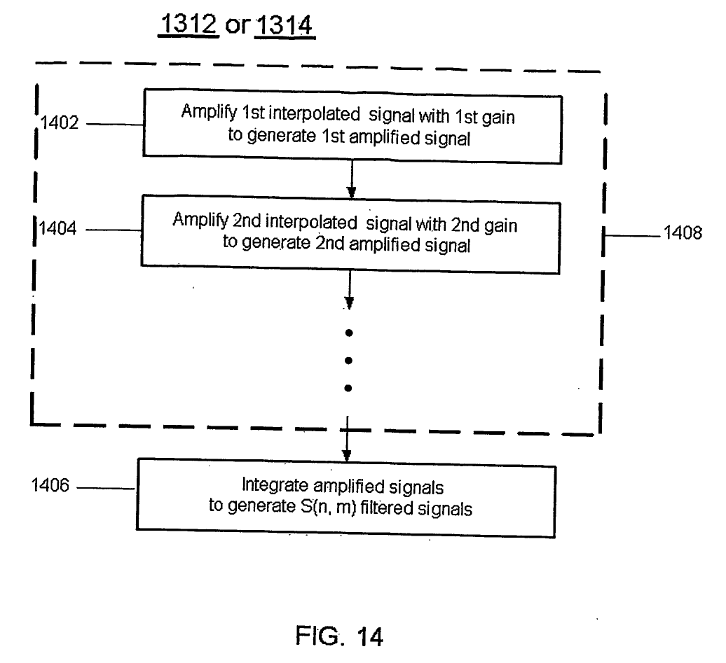

FIG. 13 illustrates an exemplary procedure for deriving AFT coefficients using interpolated pixel values. In the illustrated procedure, an incoming image signal is received by a sensor array (step 1302). The sensor array can, for example, be a conventional array having sensors with uniformly distributed spatial locations. The incoming signal is detected by the sensors of the array to generate a plurality of sensor signals (1304). The sensor signals are received by an interpolation circuit (step 1306) which interpolates the sensor signals (step 1308)—e.g., by averaging the signals—to generate a set of interpolated signals which represent the pixel values at locations defined by Farey fractions as is discussed above. The interpolated signals are received by a filter arrangement such as the analog filter 1022 illustrated in FIG. 10 or the digital filter 1502 illustrated in FIG. 15 (step 1310). The filter 1022 or 1502 derives respective weighted sums of respective sets of interpolated signals to generate respective filtered signals (step 1316). For example, a weighted sum of a first set of interpolated signals is derived to generate a first filtered signal (step 1312), and a weighted sum of a second set of interpolated signals is derived to generate a second filtered signal (step 1314). In the case of an analog filter arrangement 1022, the weighted sums derived in steps 1312 and 1314 can be produced in accordance with the procedure illustrated in FIG. 14. In the illustrated filtering procedure 1312 or 1314, the interpolated signals from a particular rows and columns are amplified with the appropriate gains to generate respective amplified signals (step 1408). For example, a first interpolated signal is amplified with a first gain to generate a first amplified signal (step 1402), a second interpolated signal is amplified with a second gain to generate a second amplified signal (step 1404), etc. The resulting amplified signals are integrated to generate the filtered signal (step 1406).

Once the respective filter outputs S(m,n) are derived, the 2-D AFT coefficients are derived (step 1112). To derive the AFT coefficients (step 1112), the filter outputs are weighted using appropriate values of a Mobius function as is described above with respect to Eqs. (15a)-(15d) above (step 1114), and the resulting weighted signals are added/summed in accordance with Eqs. (15a)-(15d) (step 1116).

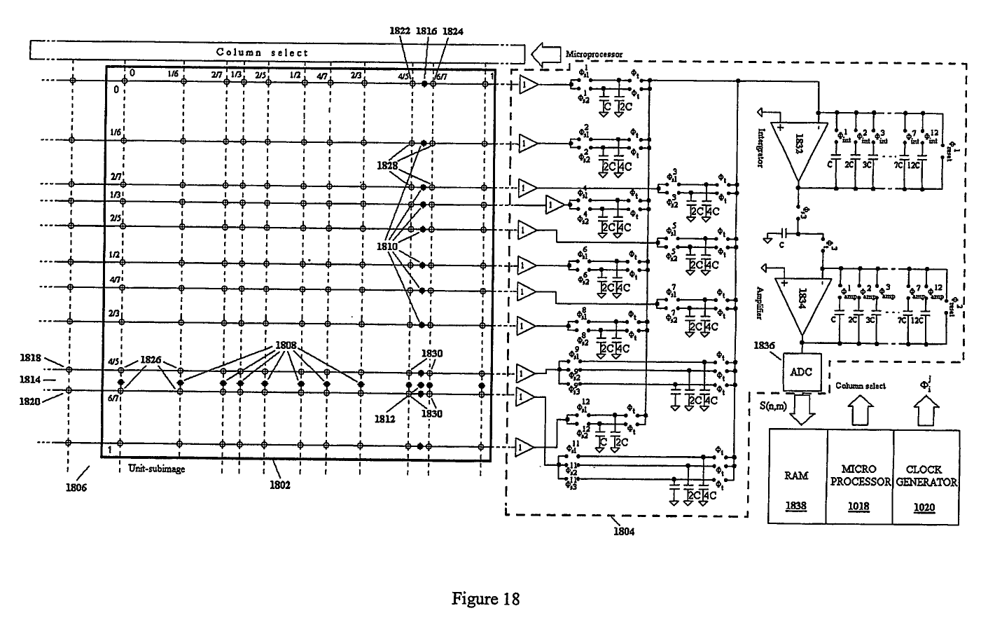

Further improvement of computational efficiency can be achieved by using an analog circuit to perform the aforementioned interpolation. FIG. 18 illustrates an exemplary analog interpolation circuit 1804 for interpolating pixel values from sensors 1806 of a sensor array portion 1802 to derive additional pixels 1808, 1810, and 1812 (pixels of the row 1814 and column 1816) for use in an AFT computation in accordance with the present invention. To interpolate pixels 1808 of the row 1814, the pixels 1826 of the rows 1818 and 1820 are used. Similarly, to interpolate the pixels 1810 of the column 1816, the pixels 1828 of the columns 1822 and 1824 are used. Although the pixels of interest are not necessarily equidistant from their neighboring pixels, they can be approximated as equidistant, which results in a 0.5% error. Each interpolated pixel value is therefore approximated as the average value of the two neighboring pixel values. A special case is the pixel 1812 at the location where row 1814 and column 1816 intersect. This pixel value will be interpolated as an average value of four neighboring pixels (pixel values 1830 at the intersections (1818,1822), (1818,1824), (1820,1822), and (1820,1824)). Assuming that the pixels of interest are equidistant from their nearest neighbors allows a minimum number of sampling capacitors to be used.

An exemplary timing cycle for calculating the filter S(3,12) using the interpolation circuit 1804 is provided below:
1. n=3, m=12,
2. Φ³ᵢₙₜ=1, Φⁱᵢₙₜ=0, where i=1, 2, 4, 5, 6, 7, 12,
3. Select Column 0
4. Φ¹ₛ₂=1, Φ⁸ₛ₂=1, other Φⁱₛⱼ=0
5. Transfer charge to integrator 1832, Φₜ=1, Φⁱₛⱼ=0
6. Select Column 1/6
7. Φ¹ₛ₁=1, Φ⁸ₛ₁=1, other Φⁱₛⱼ=0
8. Transfer charge to integrator 1832, Φₜ=1, Φⁱₛⱼ=0
9. Select Column 1/3
10. Φ¹ₛ₁=1, Φ⁸ₛ₁=1, other Φⁱₛⱼ=0
11. Transfer charge to integrator 1832, Φₜ=1, Φⁱₛⱼ=0
12. Select Column 1/2
13. Φ¹ₛ₁=1, Φ⁸ₛ₁=1, other Φⁱₛⱼ=0
14. Transfer charge to integrator 1832, Φₜ=1, Φⁱₛⱼ=0
15. Select Column 2/3
16. Φ¹ₛ₁=1, Φ⁸ₛ₁=1, other Φⁱₛⱼ=0
17. Transfer charge to integrator 1832, Φₜ=1, Φⁱₛⱼ=0
18. Select Column 4/5—interpolation column
19. Φ¹ₛ₁=1, Φ⁸ₛ₁=1—note that values in column 4/5 are sampled with gain 2 instead of gain 4
20. Transfer charge to integrator 1832, Φₜ=1, Φⁱₛⱼ=0
21. Select Column 6/7—interpolation column
22. Φ¹ₛ₁=1, Φ⁸ₛ₁=1, other Φⁱₛⱼ=0—note that values in column 6/7 are sampled with the gain 2 instead of gain 4
23. Transfer charge to integrator 1832, Φₜ=1, Φⁱₛⱼ=0
24. Sample the integrators output, Φₛ₃=1
25. Φ¹²ₐₘₚ=1, Φⁱₐₘₚ=0, where i=1, 2, 3, 4, 5, 6, 7,
26. Transfer charge to amplifier 1834, Φₛ₃=0, Φₜ₃=1
27. Perform AD conversion using ADC 1836 and store the digital value S(3,12) in RAM 1838
28. Reset the integrator and amplifier

Table 4 presents a comparison of the computational efficiencies of several different methods for computing a 1-D, 8-point DCT, including the AFT method of the present invention. The comparison is expressed in terms of the respective numbers of various types of operations used to compute the I-D DCT:

TABLE 4

| | Conventional | Fast DCT in | Fast DCT in | |
|---|---|---|---|---|
| | DCT | [Chen 1977] | [Narasimha 1978] | AFT |
| Additions | 56 | 26 | NA | 33 |
| Multiplications | 42 | 16 | 18 | 7 |
| Total Operations | 1820 | 282 | 350 | 82 |
| (8 pt) 1-D DCT | | | | |
| Total Operations | 493 | 12 | 18 | 1 |
| (8 × 8) 2-D DCT | | | | |
| Normalized to | | | | |
| AFT | | | | |

It can be seen from Table 4 that, in terms of the total number of operations, the AFT method of the present invention is approximately 3.4 times as efficient as the most efficient prior art method for computing a 1-D DCT. Furthermore, because the number of total operations in the 2-D case is approximately proportional to the square of the number of computations in the 1-D case, the AFT method of the present invention is approximately 12 times as efficient as the most efficient prior art method for computing a 2-D DCT. In addition, because the multiplications in the AFT computation comprise pre-scaling of the respective pixel intensities by integer values, these multiplications can be readily implemented using analog circuits such as the filter 1022 illustrated in FIG. 10. By effectively eliminating most of the digital multiplications, such an analog filter 1022 allows the AFT system of the present invention to use 73 times fewer computations than the most efficient prior art system.

Although the present invention has been described in connection with specific exemplary embodiments, it should be understood that various changes, substitutions, and alterations can be made to the disclosed embodiments without departing from the spirit and scope of the invention as set forth in the appended claims.

### APPENDIX A

This Appendix provides a proof of the following relation:

$$S ( n , m , {p}_{ref} , {q}_{ref} ) = {\sum }_{j such that n \vert j} {\sum }_{k such that m \vert k} {a}_{j , k} ( {p}_{ref} , {q}_{ref} ) \qquad ( A \text{-} 1 )$$

The outputs of the filters are as follows:

$$S ( n , m , {p}_{ref} , {q}_{ref} ) = \frac{1}{n} \frac{1}{m} {\sum }_{j = 1}^{n - 1} {\sum }_{k = 1}^{m - 1} A ( {p}_{ref} - \frac{j}{n} , {q}_{ref} - \frac{k}{m} ) \qquad ( A \text{-} 2 )$$

and the Fourier Series extension of the image A is provided by Eqs. (6) and (7), which are reproduced as follows:

$$\begin{matrix}A ( {p}_{ref} , {q}_{ref} ) = {\sum }_{k = 1}^{∞} {\sum }_{l = 1}^{∞} {a}_{k , l} ( {p}_{ref} , {q}_{ref} ) & ( A \text{-} 3 a ) \\ {a}_{k , l} ( {p}_{ref} , {q}_{ref} ) = {A}_{k , l} cos ( 2 π {kp}_{ref} + {θ}_{k} ) cos ( 2 π1 {q}_{ref} + {θ}_{l} ) & ( A \text{-} 3 b )\end{matrix}$$

Thus the filters' output formula (Eq. (A-2)) can be written as follows:

$$S ( n , m , {p}_{ref} , {q}_{ref} ) = \frac{1}{n} \frac{1}{m} {\sum }_{j = 1}^{n - 1} {\sum }_{k = 1}^{m - 1} {\sum }_{o = 1}^{∞} {\sum }_{r = 1}^{∞} {A}_{o , p} Re \{ {e}^{j ( 2 \cdot π \cdot o \cdot ( t - \frac{j}{n} ) + {θ}_{o} )} \} \cdot Re \{ {e}^{j ( 2 \cdot π \cdot r \cdot ( τ - \frac{k}{m} ) + {θ}_{r} )} \} \qquad ( A \text{-} 4 )$$

Rearranging the summation order, Equation (A-4) can be written as in (A-5)

$$S ( n , m , {p}_{ref} , {q}_{ref} ) = {\sum }_{o = 1}^{∞} {\sum }_{r = 1}^{∞} {a}_{o , r} ( {p}_{ref} , {q}_{ref} ) \cdot \frac{1}{n} {\sum }_{j = 1}^{n - 1} Re \{ {e}^{- j ( 2 \cdot π \cdot o \frac{j}{n} )} \} \cdot \frac{1}{m} {\sum }_{k = 1}^{n - 1} Re \{ {e}^{- j ( 2 \cdot π \cdot r \cdot \frac{k}{m} )} \} \qquad ( A \text{-} 5 )$$

Having the relation (A-6), the filters' outputs become as in (A-7)

$$\begin{matrix}\frac{1}{n} {\sum }_{j = 1}^{n - 1} Re \{ {e}^{- j ( 2 \cdot π \cdot o \cdot \frac{j}{n} )} \} = \{ \begin{matrix}1 & n \vert o \\ 0 & otherwise\end{matrix} & ( A \text{-} 6 ) \\ \begin{matrix}S ( n , m , {p}_{ref} , {q}_{ref} ) = {\sum }_{o = 1}^{∞} {\sum }_{r = 1}^{∞} {a}_{on , rm} ( {p}_{ref} , {q}_{ref} ) \\ = {\sum }_{j such that k n \vert j} {\sum }_{k such that m \vert k} {a}_{j , k} ( {p}_{ref} , {q}_{ref} )\end{matrix} & ( A \text{-} 7 )\end{matrix}$$

### APPENDIX B

This Appendix provides a proof of the following relation:

$${a}_{k , 1} ( {p}_{ref} , {q}_{ref} ) = {\sum }_{m = 1}^{∞} {\sum }_{n = 1}^{∞} {μ}_{2} ( m , n ) \cdot S ( mk , nl , {p}_{ref} , {q}_{ref} ) \\ for k , 1 = 1 , 2 , … N \qquad ( B \text{-} 1 )$$

The Kroneker function is defined as follows:

δ(n,m)=1 for n=m, (B-2a)

δ(n,m)=0 elsewhere, (B-2b)

The Mobius function μ₁ and Kroneker function δ are related as follows:

$$δ ( m , n ) = {\sum }_{d \vert ( m / n )} {μ}_{1} ( d ) = \{ \begin{matrix}1 , & if \frac{m}{n} = 1 \\ 0 , & otherwise\end{matrix} \qquad ( B \text{-} 3 )$$

The values of m and n are positive integers and summations are carried out over all positive integer values of d that exactly divide the positive integer m/n.
In order to prove the relation in Eq. (B-1), Eqs. (B-3) and (9) can be used to derive the following relations:

$${\sum }_{m = 1}^{∞} {\sum }_{n = 1}^{∞} {μ}_{2} ( m , n ) \cdot S ( mk , nl , {p}_{ref} , {q}_{ref} ) = {\sum }_{m = 1}^{∞} {\sum }_{n = 1}^{∞} {μ}_{1} ( m ) {μ}_{1} ( n ) {\sum }_{p = 1}^{∞} {\sum }_{q = 1}^{∞} {a}_{mkpnlq} ( {p}_{ref} , {q}_{ref} ) = {\sum }_{w = 1}^{∞} {\sum }_{v = 1}^{∞} {a}_{w , v} ( {p}_{ref} , {q}_{ref} ) ( {\sum }_{m \vert w / k} {μ}_{1} ( m ) ) ( {\sum }_{n \vert v / l} {μ}_{1} ( n ) ) = {\sum }_{w = 1}^{∞} {\sum }_{v = 1}^{∞} {a}_{w , v} ( {p}_{ref} , {q}_{ref} ) δ ( w , k ) \cdot δ ( v , l ) = {a}_{k , l} ( {p}_{ref} , {q}_{ref} ) \qquad ( B \text{-} 4 )$$

### APPENDIX C

### 2D DCT and 2DAFT Coefficients Equality

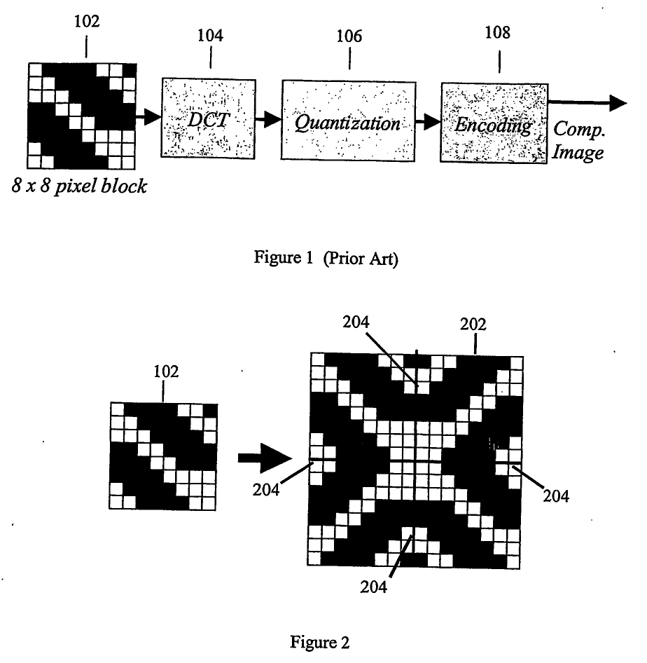

Image X is the extended version of the unit area sub-image A (as shown in FIG. 1). According to the two-dimensional case of the Nyquist reconstruction formula, the continuous image X can be represented by its samples as follows.

$$X ( p , q ) = {\sum }_{n = - ∞}^{∞} {\sum }_{m = - ∞}^{∞} X [ ( n + \frac{1}{2} ) T , ( m + \frac{1}{2} ) T ] \cdot sinc ( \frac{p - ( n + \frac{1}{2} ) T}{T} ) \cdot sinc ( \frac{q - ( m + \frac{1}{2} ) T}{T} ) \qquad ( C \text{-} 1 )$$

Without losing generality we will assume that the sampling period T is the same in both dimensions and equals ⅛. As a result, there are 16×16 samples. Let us assume that the image X is periodic with period 2×2 units. Thus, Equation (C-1) can be written as follows:

$$X ( p , q ) = {\sum }_{n = 0}^{15} {\sum }_{m = 0}^{15} X [ ( n + \frac{1}{2} ) T , ( m + \frac{1}{2} ) T ] . {\sum }_{k = - ∞}^{∞} sinc ( \frac{p - ( 16 k + n + \frac{1}{2} ) T}{T} ) \cdot {\sum }_{l = - ∞}^{∞} sinc ( \frac{q - ( 16 l + m + \frac{1}{2} ) T}{T} ) \qquad ( C \text{-} 2 )$$

It can be shown using the inverse Fourier transform and the dual form of the Poisson formula that the summation of the sinc-functions is equal to the right side of Eq. (C-3):

$${\sum }_{k = - ∞}^{∞} sinc ( \frac{p - ( 16 \cdot k + n + \frac{1}{2} ) T}{T} ) = \frac{1}{{}^{-} 16} {\sum }_{k = - 8}^{8} {e}^{j \frac{2 \cdot π \cdot k}{16 \cdot T} ( p - \frac{T}{2} - nT )} \qquad ( C \text{-} 3 )$$

Based on Eq. (C-3), Eq. (C-2) can be written as follows:

$$X ( p , q ) = {\sum }_{n = 0}^{15} {\sum }_{m = 0}^{15} X [ ( n + \frac{1}{2} ) T , ( m + \frac{1}{2} ) T ] \cdot \begin{matrix}\frac{1}{16} {\sum }_{k = - 8}^{8} {e}^{j \frac{2 \cdot π \cdot k}{16 T} ( p - \frac{T}{2} - nT )} \cdot \frac{1}{16} {\sum }_{k = - 8}^{8} {e}^{j \frac{2 \cdot π \cdot l}{16 T} ( q - \frac{T}{2} - mT )}\end{matrix} \qquad ( C \text{-} 4 )$$

Because X(p, q) is the extended version of the image A(p, q), as expressed in (C-5), Eq. (C-4) can be rearranged into Eq. (C-6)

$$\begin{matrix}X ( p , q ) = \{ \begin{matrix}A ( p , q ) & 0 \leq p < 1 , 0 \leq q < 1 , \\ A ( 2 - p , q ) & 1 \leq p < 2 , 0 \leq q < 1 , \\ A ( p , 2 - q ) & 0 \leq p < 1 , 1 \leq q < 2 , \\ A ( 2 - t , 2 - q ) & 1 \leq p < 2 , 1 \leq q < 2\end{matrix} & ( C \text{-} 5 ) \\ X ( p , q ) = {\sum }_{n = 0}^{7} {\sum }_{m = 0}^{7} A [ ( n + \frac{1}{2} ) T , ( m + \frac{1}{2} ) T ] \cdot \frac{1}{8} {\sum }_{k = - 8}^{8} {e}^{j \frac{2 \cdot π \cdot k}{16 T} p} cos ( k π ) cos ( \frac{π \cdot k}{16} ( 15 - 2 n ) ) \cdot \frac{1}{8} {\sum }_{l = - 8}^{8} {e}^{j \frac{2 \cdot π \cdot l}{16 \cdot T} q} cos ( 1 π ) cos ( \frac{π \cdot 1}{16} ( 15 - 2 m ) ) & ( C \text{-} 6 )\end{matrix}$$

The product term of the cosine functions is as follows:

$$cos ( k π ) cos ( \frac{π \cdot k}{16} ( 15 - 2 n ) ) = cos ( \frac{π \cdot k \cdot ( 2 n + 1 )}{16} ) \qquad ( C \text{-} 7 )$$

Replacing the product terms with (C-7) and rearranging the order of the summations Equation (C-6) becomes the following:

$$X ( p , q ) = {\sum }_{k = - 8}^{8} {\sum }_{l = - 8}^{8} {e}^{j \cdot π \cdot k \cdot p} \cdot {e}^{j \cdot π \cdot l \cdot q} \cdot \frac{1}{64} {\sum }_{n = 0}^{7} {\sum }_{m = 0}^{7} A [ ( n + \frac{1}{2} ) T , ( m + \frac{1}{2 } ) T ] \cdot cos ( \frac{π \cdot k \cdot ( 2 n + 1 )}{16} ) \cdot cos ( \frac{π \cdot l \cdot ( 2 m + 1 )}{16} ) \qquad ( C \text{-} 8 )$$

From Eq. (C-8) it can be seen that the (n,m) summation term does not depend on the sign of k and l. Also, according to the definition of the two-dimensional DCT given in (C-10), Eq. (C-8) can be written as follows:

$$X ( p , q ) = \frac{1}{64} {\sum }_{n = 0}^{7} {\sum }_{m = 0}^{7} A [ ( n + \frac{1}{2} ) T , ( m + \frac{1}{2} ) T ] ++ {\sum }_{k = 1}^{8} ( \frac{1}{32} {\sum }_{n = 0}^{7} {\sum }_{m = 0}^{7} A [ ( n + \frac{1}{2} ) T , ( m + \frac{1}{2} ) T ] ) . cos ( \frac{π \cdot k \cdot ( 2 n + 1 )}{16} ) \cdot cos ( k \cdot π \cdot p ) ++ {\sum }_{l = 1}^{8} ( \frac{1}{32} {\sum }_{n = 0}^{7} {\sum }_{m = 0}^{7} A [ ( n + \frac{1}{2 } ) T , ( m + \frac{1}{2} ) T ] ) \cdot cos ( \frac{π \cdot l \cdot ( 2 m + 1 )}{16} ) \cdot cos ( l \cdot π \cdot q ) ++ {\sum }_{k = 1}^{8} {\sum }_{l = 1}^{8} ( \frac{1}{64} {\sum }_{n = 0}^{7} {\sum }_{m = 0}^{7} A [ ( n + \frac{1}{2} ) T , ( m + \frac{1}{2} ) T ] \cdot cos ( \frac{π \cdot k \cdot ( 2 n + 1 )}{16} ) \cdot cos ( \frac{π \cdot l \cdot ( 2 m + 1 )}{16} ) ) \cdot cos ( k \cdot π \cdot p ) cos ( l \cdot π \cdot q ) \qquad ( C \text{-} 9 )$$

The definition of the two-dimensional DCT is as follows:

$$DCT \{ A \} ( k , l ) = {\sum }_{n = 0}^{N - 1} {\sum }_{m = 0}^{N - 1} α ( k ) \cdot α ( l ) \cdot A [ ( n + \frac{1}{2} ) T , ( m + \frac{1}{2} ) T ] \cdot cos ( \frac{π \cdot k \cdot ( 2 n + 1 )}{2 N} ) \cdot cos ( \frac{π \cdot l \cdot ( 2 m + 1 )}{2 N} ) \qquad ( C \text{-} 10 )$$

where:

$$α ( 0 ) = \sqrt{\frac{1}{N}} , α ( k ) = \sqrt{\frac{2}{N}} , k = 1 \text{,} 2 \text{,} 3 , … N - 1$$

Eq. (C-9) can therefore be written as follows:

$$X ( p , q ) = \frac{DCT \{ A \} ( 0 , 0 )}{8} + \begin{matrix}{\sum }_{k = 1}^{8} \frac{DCT \{ A \} ( k , 0 )}{4 \sqrt{2}} cos ( k \cdot π \cdot p ) ++\end{matrix} {\sum }_{l = 1}^{8} \frac{DCT \{ A \} ( 0 , 1 )}{4 \sqrt{2}} cos ( 1 \cdot π \cdot q ) + {\sum }_{k = 1}^{8} {\sum }_{l = 1}^{8} \frac{DCT \{ A \} ( k , l )}{4} cos ( k \cdot π \cdot p ) cos ( l \cdot π \cdot q ) \qquad ( C \text{-} 11 )$$

In addition, the extended image X(p,q) can be represented by its two-dimensional Fourier series:

$$X ( p , q ) = E [ X ] + {\sum }_{k = 1}^{8} \overline{{x}_{k , 0}} cos ( k \cdot π \cdot p ) ++ {\sum }_{l = 1}^{8} {x}_{0 , l} cos ( 1 \cdot π \cdot q ) + {\sum }_{k = 1}^{8} {\sum }_{l = 1}^{8} {x}_{k , l} cos ( k \cdot π \cdot p ) cos ( 1 \cdot π \cdot q ) \qquad ( C \text{-} 12 )$$

where x_{k,l} (k,l=1, 2 . . . 8) are 2DAFT coefficients of the extended image X. The second and third terms of Eq. (C-12) are due to the presence of local row and column non-zero mean values. The coefficients inside the second term are calculated as the ID AFT of the row-means; and the coefficients inside the third term are calculated as the ID AFT of the column-means.

Having representations (C-11) and (C-12) of the image X(t,τ), and having orthogonal cosine functions in both formulae, we can conclude that the 2DAFT and DCT coefficients are equal except for a constant multiplicative factor in each DCT coefficient:

DCT{A}(0,0)=8*E[A],

DCT{A}(k,0)=4=29 \sqrt{2}; x̅_̅{̅k̅,̅0̅}̅ k=1, 2, 3, . . . N−1

DCT{A}(0,l)=4\sqrt{2}* x̅_̅{̅0̅,̅l̅}̅ l=1, 2, 3, . . . N−1

DCT{A}(k,l)=4*x_{k,l} k=1, 2, 3, . . . N−1, l=1, 2, 3, . . . N−1 (C-13)

We claim:

1. A sensing apparatus, comprising:
a sensor array comprising at least a first sensor and a second sensor, the sensor array having associated therewith a spatial coordinate system, the first sensor having a first sensor location, the second sensor having a second sensor location, the first sensor location being proximate to a location of a first extremum of at least one basis function of a domain transform, the at least one basis function having at least one spatial coordinate defined according to the spatial coordinate system, the second sensor location being proximate to a location of a second extremum of the at least one basis function; and
at least one filter coupled to receive a signal from the first sensor, the at least one filter being further coupled to receive a signal from the second sensor, the at least one filter being configured to generate a first filter output signal, the first filter output signal comprising a weighted sum of at least the signal from the first sensor and the signal from the second sensor.

2. A sensing apparatus according to claim 1, wherein the domain transform comprises at least one of a Fourier transform and a cosine transform.

3. A sensing apparatus according to claim 2, wherein the first sensor location has a first distance from a reference location in a unit cell of the sensor array, the unit cell having a unit cell size, the second sensor location having a second distance from the reference location, the first distance being essentially equal to a product of the unit cell size and a first Farey fraction, the second distance being essentially equal to a product of the unit cell size and a second Farey fraction.

4. A sensing apparatus according to claim 1, wherein the first sensor location has a first distance from a reference location in a unit cell of the sensor array, the unit cell having a unit cell size, the second sensor location having a second distance from the reference location, the first distance being essentially equal to a product of the unit cell size and a first Farey fraction, the second distance being essentially equal to a product of the unit cell size and a second Farey fraction.

5. A sensing apparatus according to claim 4, wherein the sensor array further comprises a third sensor and a fourth sensor, the third sensor having a third sensor location, the fourth sensor having a fourth sensor location, the third sensor location having a third distance from the reference location, the fourth sensor location having a fourth distance from the reference location, the third distance being essentially equal to a product of the unit cell size and a third Farey fraction, the fourth distance being essentially equal to a product of the unit cell size and a fourth Farey fraction, the at least one filter comprising:
a first filter coupled to receive the signal from the first sensor, the first filter being further coupled to receive the signal from the second sensor, the first filter being configured to generate the first filter output signal;
a second filter coupled to receive a signal from the third sensor, the second filter being further coupled to receive a signal from the fourth sensor, the second filter being configured to generate a second filter output signal, the second filter output signal comprising a weighted sum of at least the signal from the third sensor and the signal from the fourth sensor; and
a third filter coupled to receive the first and second filter output signals, the third filter being configured to generate a third filter output signal, the third filter output signal comprising a sum of:
a product of the first filter output signal and a first value of a Mobius function, and
a product of the second filter output signal and a second value of the Mobius function.

6. A sensing apparatus according to claim 1, wherein the sensor array further comprises a third sensor and a fourth sensor, the third sensor having a third sensor location, the fourth sensor having a fourth sensor location, the third sensor location being proximate to a location of a third extremum of the at least one basis function, the fourth sensor location being proximate to a location of a fourth extremum of the at least one basis function, the at least one filter comprising:
a first filter coupled to receive the signal from the first sensor, the first filter being further coupled to receive the signal from the second sensor, the first filter being configured to generate the first filter output signal;
a second filter coupled to receive a signal from the third sensor, the second filter being further coupled to receive a signal from the fourth sensor, the second filter being configured to generate a second filter output signal, the second filter output signal comprising a weighted sum of at least the signal from the third sensor and the signal from the fourth sensor; and
a third filter coupled to receive the first and second filter output signals, the third filter being configured to generate a third filter output signal, the third filter output signal comprising a sum of:
a product of the first filter output signal and a first value of a Mobius function, and
a product of the second filter output signal and a second value of the Mobius function.

7. A sensing apparatus according to claim 6, wherein the first, second, third, and fourth sensors are included in a plurality of sensors, the plurality of sensors further including fifth, sixth, seventh, and eighth sensors, the plurality of sensors being configured to generate a plurality of sensor signals, the plurality of sensor signals including the respective signals from the first, second, third, and fourth sensors, the plurality of sensor signals further including respective signals from the fifth, sixth, seventh, and eighth sensors, the at least one filter further comprising:
a fourth filter coupled to receive the respective signals from the fifth and sixth sensors, the fourth filter being configured to generate a fourth filter output signal comprising a weighted sum of at least the respective signals from the fifth and sixth sensors;
a fifth filter coupled to receive the respective signals from the seventh and eighth sensors, the fifth filter being configured to generate a fifth filter output signal comprising a weighted sum of at least the respective signals from the seventh and eighth sensors; and
a sixth filter coupled to receive the fourth and fifth filter output signals, the sixth filter being configured to generate a sixth filter output signal comprising a sum of:
a product of the fourth filter output signal and a third value of the Mobius function, and
a product of the fifth filter output signal and a fourth value of the Mobius function, the sensing apparatus further comprising a first correction circuit, the first correction circuit being configured to generate a first correction signal, the first correction signal comprising a product of:
(a) a sum of values of the Mobius function, and
(b) at least one of: (i) a mean value of the plurality of signals, and (ii) the sixth filter output signal, the first correction circuit being further configured to generate a first corrected filter output signal, the first corrected filter output signal comprising a sum or difference of the third filter output signal and the first correction signal.

8. A sensing apparatus according to claim 7, wherein the plurality of sensors further includes ninth, tenth, eleventh, and twelfth sensors, the plurality of sensor signals further including respective signals from the ninth, eleventh, and twelfth sensors, the at least one filter further comprising:
a seventh filter coupled to receive the respective signals from the ninth and tenth sensors, the seventh filter being configured to generate a seventh filter output signal comprising a weighted sum of at least the respective signals from the ninth and tenth sensors;
an eighth filter coupled to receive the respective signals from the eleventh and twelfth sensors, the eighth filter being configured to generate an eighth filter output signal comprising a weighted sum of at least the respective signals from the eleventh and twelfth sensors; and
a ninth filter coupled to receive the seventh and eighth filter output signals, the ninth filter being configured to generate a ninth filter output signal comprising a sum of:
a product of the seventh filter output signal and a fifth value of the Mobius function, and
a product of the eighth filter output signal and a sixth value of the Mobius function, the sensing apparatus further comprising a second correction circuit, the second correction circuit being configured to generate a second correction signal, the second correction signal comprising the eighth filter output signal, the second correction circuit being further configured to generate a second corrected filter output signal, the second corrected filter output signal comprising a sum or difference of the first corrected filter output signal and the second correction signal.

9. A sensing apparatus according to claim 6, wherein the first, second, third, and fourth sensors are included in a plurality of sensors, the plurality of sensors further including fifth, sixth, seventh, and eighth sensors, the plurality of sensors being configured to generate a plurality of sensor signals, the plurality of sensor signals including the respective signals from the first, second, third, and fourth sensors, the plurality of sensor signals further including respective signals from the fifth, sixth, seventh, and eighth sensors, the at least one filter further comprising:
a fourth filter coupled to receive the respective signals from the fifth and sixth sensors, the fourth filter being configured to generate a fourth filter output signal comprising a weighted sum of at least the respective signals from the fifth and sixth sensors;
a fifth filter coupled to receive the respective signals from the seventh and eighth sensors, the fifth filter being configured to generate a fifth filter output signal comprising a weighted sum of at least the respective signals from the seventh and eighth sensors; and
a sixth filter coupled to receive the fourth and fifth filter output signals, the sixth filter being configured to generate a sixth filter output signal comprising a sum of:
a product of the fourth filter output signal and a third value of the Mobius function, and
a product of the fifth filter output signal and a fourth value of the Mobius function, the sensing apparatus further comprising a correction circuit, the correction circuit being configured to generate a correction signal, the correction signal comprising the sixth filter output signal, the correction circuit being further configured to generate a corrected filter output signal, the corrected filter output signal comprising a sum or difference of the third filter output signal and the correction signal.

10. A sensing apparatus according to claim 1, wherein the at least one filter comprises:
a first amplifier coupled to receive the signal from the first sensor for generating a first amplifier output signal;
a second amplifier coupled to receive the signal from the second sensor for generating a second amplifier output signal; and
an integrator coupled to receive and integrate the first and second amplifier output signals for generating an integrated signal, the first filter output signal comprising the integrated signal.

11. A sensing apparatus according to claim 1, wherein the at least one filter comprises a digital filter.

12. A sensing apparatus, comprising:
a sensor array comprising a plurality of sensors, the plurality of sensors including at least a first sensor and a second sensor, the sensor array having associated therewith a spatial coordinate system, the first sensor having a first sensor location, the second sensor having a second sensor location, the sensor array being coupled to receive an incoming signal, the incoming signal having a first incoming signal value at the first sensor location, the incoming signal having a second incoming signal value at the second sensor location; and
an interpolation circuit coupled to receive a signal from the first sensor, the interpolation circuit being further coupled to receive a signal from the second sensor, the signal from the first sensor representing the first incoming signal value, the signal from the second sensor representing the second incoming signal value, the interpolation circuit being configured to interpolate the signal from the first sensor and the signal from the second sensor for generating a first interpolated signal, the first interpolated signal representing an approximate value of the incoming signal at a location proximate to a first extremum of at least one basis function of a domain transform, the at least one basis function having at least one spatial coordinate defined according to the spatial coordinate system.

13. A sensing apparatus according to claim 12, wherein the domain transform comprises at least one of a Fourier transform and a cosine transform.

14. A sensing apparatus according to claim 12, wherein the interpolation circuit is further configured to interpolate a first set of at least two signals from the plurality of sensors for generating a second interpolated signal, the second interpolated signal representing an approximate value of the incoming signal at a location proximate to a second extremum of the at least one basis function, the sensing apparatus further comprising at least one filter coupled to receive the first and second interpolated signals, the at least one filter being configured to generate a first filter output signal, the first filter output signal comprising a weighted sum of at least the first and second interpolated signals.

15. A sensing apparatus according to claim 14, wherein the interpolation circuit is further configured to interpolate a second set of at least two signals from the plurality of sensors for generating a third interpolated signal, the third interpolated signal representing an approximate value of the incoming signal at a location proximate to a third extremum of the at least one basis function, the interpolation circuit being further configured to interpolate a third set of at least two signals from the plurality of sensors for generating a fourth interpolated signal, the fourth interpolated signal representing an approximate value of the incoming signal at a location proximate to a fourth extremum of the at least one basis function, the at least one filter comprising:
a first filter coupled to receive the first interpolated signal from the interpolation circuit, the first filter being further coupled to receive the second interpolated signal from the interpolation circuit, the first filter being configured to generate the first filter output signal;
a second filter coupled to receive the third interpolated signal from the interpolation circuit, the second filter being further coupled to receive the fourth interpolated signal from the interpolation circuit, the second filter being configured to generate a second filter output signal, the second filter output signal comprising a weighted sum of at least the third and fourth interpolated signals; and
a third filter coupled to receive the first and second filter output signals, the third filter being configured to generate a third filter output signal, the third filter output signal comprising a sum of:
a product of the first filter output signal and a first value of a Mobius function, and
a product of the second filter output signal and a second value of the Mobius function.

16. A sensing apparatus according to claim 14, wherein the at least one filter comprises:
a first amplifier coupled to receive the first integrated signal from the interpolation circuit for generating a first amplifier output signal;
a second amplifier coupled to receive the second interpolated signal from the interpolation circuit for generating a second amplifier output signal; and
an integrator coupled to receive and integrate the first and second amplifier output signals for generating an integrated signal, the first filter output signal comprising the integrated signal.

17. A sensing apparatus according to claim 14, wherein the at least one filter comprises a digital filter.

18. A sensing method, comprising:
receiving an incoming signal by a sensor array comprising at least a first sensor and a second sensor, the sensor array having associated therewith a spatial coordinate system, the first sensor having a first sensor location, the second sensor having a second sensor location, the first sensor location being proximate to a location of a first extremum of at least one basis function of a domain transform, the at least one basis function having at least one spatial coordinate defined according to the spatial coordinate system, the second sensor location being proximate to a location of a second extremum of the at least one basis function;
detecting the incoming signal by the first sensor for generating a first sensor signal;
detecting the incoming signal by the second sensor for generating a second sensor signal;
receiving the first sensor signal by the at least one filter;
receiving the second sensor signal by the at least one filter; and
generating a first filtered signal by the at least one filter, the first filtered signal comprising a weighted sum of at least the first sensor signal and the second sensor signal.

19. A method according to claim 18, wherein the sensor array further comprises a third sensor and a fourth sensor, the third sensor having a third sensor location, the fourth sensor having a fourth sensor location, the third sensor location being proximate to a location of a third extremum of the at least one basis function, the fourth sensor location being proximate to a location of a fourth extremum of the at least one basis function, the method further comprising:
detecting the incoming signal by the third sensor for generating a third sensor signal;
detecting the incoming signal by the fourth sensor for generating a fourth sensor signal;
receiving the third sensor signal by the at least one filter;
receiving the fourth sensor signal by the at least one filter;
generating a second filtered signal by the at least one filter, the second filtered signal comprising a weighted sum of at least the third sensor signal and the fourth sensor signal; and
generating a third filtered signal by the at least one filter, the third filtered signal comprising a sum of:
a product of the first filtered signal and a first value of a Mobius function, and
a product of the second filtered signal and a second value of the Mobius function.

20. A method according to claim 19, wherein the first, second, third, and fourth sensors are included in a plurality of sensors, the plurality of sensors further including fifth, sixth, seventh, and eighth sensors, the first, second, third, and fourth sensor signals being included in a plurality of sensor signals, the method further comprising:
detecting the incoming signal by the fifth sensor for generating a fifth sensor signal;
detecting the incoming signal by the sixth sensor for generating a sixth sensor signal;
detecting the incoming signal by the seventh sensor for generating a seventh sensor signal;
detecting the incoming signal by the eighth sensor for generating an eighth sensor signal, the plurality of signals further including the fifth, sixth, seventh, and eighth sensor signals;
receiving the fifth, sixth, seventh, and eighth sensor signals by the at least one filter;
generating a fourth filtered signal by the at least one filter, the fourth filtered signal comprising a weighted sum of at least the fifth and sixth sensor signals;
generating a fifth filtered signal by the at least one filter, the fifth filtered signal comprising a weighted sum of at least the seventh and eighth sensor signals;
generating a sixth filtered signal by the at least one filter, the sixth filtered signal comprising a sum of:
a product of the fourth filtered signal and a third value of the Mobius function, and
a product of the fifth filtered signal and a fourth value of the Mobius function;
generating a first correction signal, the first correction signal comprising a product of:
(a) a sum of values of the Mobius function, and
(b) at least one of: (i) a mean value of the plurality of signals, and (ii) the sixth filtered signal; and
generating a first corrected filter output signal, the first corrected filter output signal comprising a sum or difference of the third filtered signal and the first correction signal.

21. A method according to claim 20, wherein the plurality of sensors further includes ninth, tenth, eleventh, and twelfth sensors, the method further comprising:
detecting the incoming signal by the ninth sensor for generating a ninth sensor signal;
detecting the incoming signal by the tenth sensor for generating a tenth sensor signal;
detecting the incoming signal by the eleventh sensor for generating an eleventh sensor signal;
detecting the incoming signal by the twelfth sensor for generating a twelfth sensor signal, the plurality of signals further including the ninth, tenth, eleventh, and twelfth sensor signals;
receiving the ninth, tenth, eleventh, and twelfth sensor signals by the at least one filter;
generating a seventh filtered signal by the at least one filter, the seventh filtered signal comprising a weighted sum of at least the ninth and tenth sensor signals;
generating an eighth filtered signal by the at least one filter, the eighth filtered signal comprising a weighted sum of at least the eleventh and twelfth sensor signals;
generating a ninth filtered signal by the at least one filter, the ninth filtered signal comprising a sum of:
a product of the seventh filtered signal and a fifth value of the Mobius function, and
a product of the eighth filtered signal and a sixth value of the Mobius function;
generating a second correction signal, the second correction signal comprising the eighth filtered signal; and
generating a second corrected filter output signal, the second corrected filter output signal comprising a sum or difference of the first corrected filter output signal and the second correction signal.

22. A method according to claim 19, wherein the first, second, third, and fourth sensors are included in a plurality of sensors, the plurality of sensors further including fifth, sixth, seventh, and eighth sensors, the first, second, third, and fourth sensor signals being included in a plurality of sensor signals, the method further comprising:
detecting the incoming signal by the fifth sensor for generating a fifth sensor signal;
detecting the incoming signal by the sixth sensor for generating a sixth sensor signal;
detecting the incoming signal by the seventh sensor for generating a seventh sensor signal;
detecting the incoming signal by the eighth sensor for generating an eighth sensor signal, the plurality of signals further including the fifth, sixth, seventh, and eighth sensor signals;
receiving the fifth, sixth, seventh, and eighth sensor signals by the at least one filter;
generating a fourth filtered signal by the at least one filter, the fourth filtered signal comprising a weighted sum of at least the fifth and sixth sensor signals;
generating a fifth filtered signal by the at least one filter, the fifth filtered signal comprising a weighted sum of at least the seventh and eighth sensor signals;
generating a sixth filtered signal by the at least one filter, the sixth filtered signal comprising a sum of:
a product of the fourth filtered signal and a third value of the Mobius function, and
a product of the fifth filtered signal and a fourth value of the Mobius function;
generating a correction signal, the correction signal comprising the sixth filter output signal; and
generating a corrected filter output signal, the corrected filter output signal comprising a sum or difference of the third filtered signal and the correction signal.

23. A method according to claim 18, wherein the step of generating the first filtered signal comprises:
amplifying the first sensor signal for generating a first amplified signal;
amplifying the second sensor signal for generating a second amplified signal; and
integrating the first and second amplified signals for generating an integrated signal, the first filtered signal comprising the integrated signal.

24. A method according to claim 18, wherein the step of generating the first filtered signal comprises digitally computing the weighted sum of at least the first sensor signal and the second sensor signal.

25. A sensing method, comprising:
receiving an incoming signal by a sensor array comprising a plurality of sensors, the plurality of sensors including at least a first sensor and a second sensor, the sensor array having associated therewith a spatial coordinate system, the first sensor having a first sensor location, the second sensor having a second sensor location, the incoming signal having a first incoming signal value at the first sensor location, the incoming signal having a second incoming signal value at the second sensor location;
detecting the incoming signal by the first sensor for generating a first sensor signal, the first sensor signal representing the first incoming signal value;
detecting the incoming signal by the second sensor for generating a second sensor signal, the second sensor signal representing the second incoming signal value;
receiving the first sensor signal by an interpolation circuit;
receiving the second sensor signal by the interpolation circuit; and
interpolating the first and second sensor signals by the interpolation circuit for generating a first interpolated signal, the first interpolated signal representing an approximate value of the incoming signal at a location proximate to a first extremum of at least one basis function of a domain transform, the at least one basis function having at least one spatial coordinate defined according to the spatial coordinate system.

26. A method according to claim 25, wherein the domain transform comprises at least one of a Fourier transform and a cosine transform.

27. A method according to claim 25, further comprising:
interpolating, by the interpolation circuit, a first set of at least two signals from the plurality of sensors for generating a second interpolated signal, the second interpolated signal representing an approximate value of the incoming signal at a location proximate to a second extremum of the at least one basis function;
receiving the first and second interpolated signals by at least one filter;
generating a first filtered signal by the at least one filter, the first filtered signal comprising a weighted sum of at least the first and second interpolated signals.

28. A method according to claim 27, further comprising:
interpolating, by the interpolation circuit, a second set of at least two signals from the plurality of sensors for generating a third interpolated signal, the third interpolated signal representing an approximate value of the incoming signal at a location proximate to a third extremum of the at least one basis function;
interpolating, by the interpolation circuit, a third set of at least two signals from the plurality of sensors for generating a fourth interpolated signal, the fourth interpolated signal representing an approximate value of the incoming signal at a location proximate to a fourth extremum of the at least one basis function;
receiving the third and fourth interpolated signals by the at least one filter;
generating a second filtered signal by the at least one filter, the second filtered signal comprising a weighted sum of at least the third and fourth interpolated signals; and
generating a third filtered signal by the at least one filter, the third filtered signal comprising a sum of:
a product of the first filtered signal and a first value of a Mobius function, and
a product of the second filtered signal and a second value of the Mobius function.

29. A method according to claim 27, wherein the step of generating the first filtered signal comprises:
amplifying the first interpolated signal for generating a first amplified signal;
amplifying the second interpolated signal for generating a second amplified signal; and
integrating the first and second amplified signals for generating an integrated signal, the first filtered signal comprising the integrated signal.

30. A method according to claim 27, wherein the step of generating the first filtered signal comprises digitally computing the weighted sum of at least the first and second interpolated signals.
